(19) United States
(12) Patent Application Publication
(10) Pub. No.: US 2023/0302436 A1
(43) Pub. Date: Sep. 28, 2023

(54) OXIDATIVE PROCESSES FOR SELF-HEATING AND PYROPHORIC CATALYSTS CONTAINING ACTIVE METAL SULFIDES, AND MITIGATION OF HALIDE AND POLYTHIONIC ACID STRESS CORROSION CRACKING MECHANISMS IN PROCESS EQUIPMENT

(71) Applicant: Refined Technologies, Inc., Spring, TX (US)

(72) Inventors: James Esteban, Kingwood, TX (US); Sean Sears, The Woodlands, TX (US); Trey Schuenemann, Trabuco (CA)

(21) Appl. No.: 18/018,671

(22) PCT Filed: Jul. 28, 2021
(86) PCT No.: PCT/US21/43428

§ 371 Date: Jan. 30, 2023

Related U.S. Application Data
(60) Provisional application No. 63/059,558, filed on Jul. 31, 2020.

(51) Int. Cl. B01J 23/94; B01J 8/00; B08B 9/08; B01J 23/881; C23G 1/14

(52) U.S. Cl. CPC B01J 23/94; B01J 8/0015; B08B 9/08; B01J 23/881; C23G 1/14; B01J 2208/00707

(57) ABSTRACT

Methods and compositions for the removal of metal sulfides from spent catalysts in reactor vessels and associated equipment are described herein. Using the methods described herein, metal sulfides of a spent catalysts are converted to metal oxides and gaseous and liquid by-products when reacted with a formulation having one or more oxidizing agents. Also, using the methods described herein, metal sulfides and sulfides in the process equipment are oxidized, eliminating the potential formation of polythionic and thionic acids protecting materials from polythionic stress corrosion cracking. Also, using the methods described herein, halides (including chloride) and halide containing compounds and salts in the process equipment are removed, eliminating the potential formation of halide acids and further neutralized via pH buffering, and protecting materials from halide stress corrosion cracking.

### CROSS REFERENCE TO RELATED APPLICATION

This application claims the benefit of U.S. Provisional Application No. 63/059,558, filed Jul. 31, 2020, the entire contents of which are incorporated herein by reference.

### FIELD OF THE INVENTION

The present invention relates to methods for safely removing metal sulfides from catalyst beds in reactor vessels. More specifically, the present invention relates to methods for converting metal sulfides to metal oxides and gaseous and liquid by-products, and safe removal of said gaseous and liquid by-products from reactor vessels, allowing for safe entry into reactor vessels by technicians. The present invention further relates to methods for the safe elimination of sulfides and metal sulfide compounds present in process equipment via oxidative neutralization, mitigating polythionic acid formation on process equipment surfaces. The present invention further relates to methods for the elimination of halides, such as chlorides, mitigating halide acid formation on process equipment surfaces.

### BACKGROUND OF THE DISCLOSURE

Many catalyst materials used in the refining and petrochemical industry employ metal sulfide crystalline structures dispersed on extruded alumina substrates as active sites for the initiation of hydrogenation reactions including: heteroatom removal as in desulfurization, denitrification, and deoxygenation; hydrogen saturation of olefins and aromatics; hydrocracking reactions; among other selective hydrogenation functions. There are variations of these catalysts which contain zeolite materials as well as base metals, but functionally these catalysts remain similar in that they contain active metal sulfide components for hydrogenation. These catalysts are generally manufactured via the impregnation of metal oxides on alumina extrudates that are converted to the active metal sulfide phase during catalyst system commissioning steps, which are typically carried out within the operating process unit during initial startup of the fresh catalyst system. Over the course of operation, these catalysts become deactivated as a result of two primary mechanisms: metals poisoning and coke formation. The loss of activity from the catalyst system leads to reduced process unit conversion and the need to replace catalyst materials. Replacement of these catalysts is a complex process. Spent catalysts which contain active metal sulfide components are self-heating materials, meaning that they will spontaneously react with oxygen under standard atmospheric conditions propagating combustion reactions which release both excessive heat and noxious gases.

The refining and petrochemical manufacturing industries continues to seek out opportunities toward providing the safest working environments. A persisting major hazard in these industries continues to be catalyst handling work performed with workers entering an IDLH (Immediately Dangerous to Life and Health) inert atmosphere. Many in these industries desire to move away from “inert entry” catalyst removal methods; products or methodologies that permit this shift remains elusive. In general, catalysts used in hydroprocessing applications that contain active metal sulfides such as, for example, NiS, MoS₂, and CoS cannot be exposed to atmospheric conditions where oxygen is a component of the atmosphere. As discussed above, metal sulfides are known to spontaneously react with oxygen, resulting in the release of combustion products and excessive heat energy leading to potential fire, equipment damage/destruction, and noxious gas exposure hazards. To prevent the exposure of these materials to oxygen, industry standard practice has been to maintain inert atmospheres using nitrogen purging of reactor vessels during unloading. The inert atmosphere can create an asphyxiation hazard for catalyst handling employees. The hazards of equipment inerting with nitrogen purging has led to the death of many workers and rescue team members in industry. As such, the risk for refiners and manufacturers as well as contract workers who perform the catalyst handling maintenance is extensive.

Many components of piping systems, vessels, and equipment used in refining and petrochemicals manufacturing are constructed of austenitic stainless-steel components. While these materials of construction are very durable and offer reliable performance for equipment design and operations, certain series of the stainless-steel materials are susceptible to corrosion cracking mechanisms associated with the formation of chloride, polythionic, and thionic acids.

Many of these materials of construction are commonly used in applications where the normal operating process fluids and catalysts contain sulfurous and halide (such as chloride) compounds. These operating conditions form halide, sulfide, and metal sulfide deposits and scales on equipment surfaces which have the potential to form halide and thionic acids when exposed to conditions that favor the formation of these compounds.

The combination of the presence of oxygen, stress, and moisture can have detrimental impacts to equipment integrity when intragranular cracking occurs due to the acid interaction with the materials. Conditions which result in the formation of these cracks are most associated with maintenance periods and activities when the process equipment is opened, and halides and sulfide materials are exposed to oxygen from air ingress into the normally closed systems.

Historically, to prevent polythionic acid stress cracking, operators have treated stainless vessels with soda ash (i.e., sodium carbonate, or Na₂CO₃). In such instances, a large capacity steel tank (for example, a frac tank) of clean water in which hundreds of pounds of dry soda ash is inserted is used. The soda ash and water are mixed in the tank to form a treatment solution. The tank is then placed “upstream” of the stainless vessel in need of treatment.

The treatment solution is then injected into the bottom of the stainless equipment to be treated until full, at which point the solution exits the top of the vessel and is then pumped back into the large capacity tank. This mixture-injection-return circulation process is performed in a closed loop.

Once the treatment solution returns to the large capacity tank, an operator measures the solution for pH. Based on the measured pH, the operator is able to determine whether the treatment process was effective. If the measurement shows a pH level less than 9, the closed-loop circulation application will need to be continued while adding more soda ash to raise the pH level. If the measurement shows greater than 9, and the closed-loop application process can be terminated after a minimum of two hours, the treated tank can be drained, and pumping equipment can be disconnected from the treated tank. The closed-loop circulation approach is dictated by three main realities.

First, perpetual circulation of the treatment solution is necessary. Otherwise, the soda ash will precipitate and fall out of solution due to the limited solubility of the soda ash within the treatment solution.

Second, NACE international standards require that in the absence of a clean unit and peripheral piping (i.e., if petroleum contaminants, such as deposits of sludge, and fouling are present), the treatment must be performed on a circulatory basis (see, NACE SP0170-2018, Item No. 21002, Approved Date 2018 Sep. 10, ISBN 1-57590-039-4) Specifically, the NACE international standard requires 1) any equipment to be treated should be filled with the soda ash-containing treatment solution under an inert atmosphere to minimize oxygen contamination, 2) the equipment is treated with the treatment solution by vigorous circulation for a minimum of two hours, and 3) circulating treatment solution should be analyzed at appropriate intervals to ensure pH and chloride limits are maintained.

Third, the efficacy of the treatment process can only be ascertained by testing the soda ash-containing treatment solution on a “before” and “after” basis. In other words, the operator needs to measure the pH of the solution before it travels into and through the vessel to be treated as compared to the pH measurement afterward. To obtain that comparative measurement, the operator must circulate within a closed loop. Moreover, this measurement and testing need precludes even the thought of a once-through application.

### BRIEF DESCRIPTION OF THE DRAWINGS

FIG. 1 is a schematic flowchart of a method for removing metal sulfides from a catalyst bed in a reactor vessel and removal of sulfides and halides in a reactor system within which the reactor vessel is integrated in accordance with various aspects of the disclosure;

FIG. 2 is a schematic flowchart of another method for removing metal sulfides from a catalyst bed in a reactor vessel and removal of sulfides and halides in a reactor system within which the reactor vessel is integrated in accordance with various aspects of the disclosure;

FIG. 3 is an image of an exemplary laboratory scale system for removing metal sulfides from a spent catalyst material in accordance with various aspects of the disclosure;

FIGS. 4A-G are graphs showing data obtained from treating a spent catalyst material, in the laboratory scale system of FIG. 3, with water and subsequently subjecting it to a hot air purge in accordance with various aspects of the disclosure;

FIGS. 5A-E are graphs showing subsets of the data of FIGS. 4A-D and 4G;

FIGS. 6A-G are graphs showing data obtained from treating a spent catalyst material, in the laboratory scale system of FIG. 3, with an aqueous solution comprising 5 wt % NaNO₂, 1 wt % LDAO and 1 wt % Na₂HPO₄ and subsequently subjecting it to a hot air purge in accordance with various aspects of the disclosure;

FIGS. 7A-D are graphs showing subsets of the data of FIGS. 6D-G;

FIGS. 8A-G are graphs showing other subsets of the data of FIGS. 6A-G;

FIGS. 9A-E are graphs showing data obtained from treating a spent catalyst material, in the laboratory scale system of FIG. 3, with an aqueous solution comprising 10 wt % NaNO₂ and subsequently subjecting it to a hot air purge in accordance with various aspects of the disclosure;

FIGS. 10A-D are graphs showing subsets of the data of FIGS. 9B-E;

FIGS. 11A-E are graphs showing data obtained from treating a spent catalyst material, in the laboratory scale system of FIG. 3, with an aqueous solution comprising 10 wt % NaNO₂, 0.8 wt % LDAO and 0.8 wt % Na₂HPO₄ and subsequently subjecting it to a hot air purge in accordance with various aspects of the disclosure;

FIGS. 12A-D are graphs showing subsets of the data of FIGS. 11B-E;

FIGS. 13A-E are graphs showing data obtained from treating a spent catalyst material, in the laboratory scale system of FIG. 3, with an aqueous solution comprising 20 wt % NaNO₂, 0.5 wt % LDAO and 0.5 wt % Na₂HPO₄ and subsequently subjecting it to a hot air purge in accordance with various aspects of the disclosure;

FIGS. 14A-D are graph showing subsets of the data of FIGS. 13B-E.

FIGS. 15A-D are graphs showing data obtained from treating a spent catalyst material, in the laboratory scale system of FIG. 3, with an aqueous solution comprising 20 wt % NaNO₂, 0.5 wt % LDAO and 0.5 wt % Na₂HPO₄ and subsequently subjecting it to a hot air purge in accordance with various aspects of the disclosure; and

FIG. 16A-C are graphs showing subsets of the VOC, H₂S and SO₂ vent gas composition data of FIGS. 15B-D.

FIG. 17 is a schematic diagram of the commercial reactor system treated in Example 7;

FIG. 18 is a graph showing operating data (reactor temperatures and chemical injection volumes) of the commercial reactor system treated in Example 7; the data line RX1In corresponds to the temperature in ° F. measured at the inlet of the Guard Reactor, the data line RX2Out corresponds to the temperature in ° F. measured at the outlet of the Main Reactor, the data line QR corresponds to the total volume in gallons of oxidizing solution injected, and the data line PH corresponds to the total volume in gallons of pH buffering solution injected.

FIG. 19 is a graph showing data obtained from treating the commercial reactor system shown schematically by FIG. 17 in Example 7, with an aqueous solution comprising 20 wt % NaNO₂, 0.5 wt % LDAO and 0.5 wt % Na₂HPO₄ and a pH buffer solution in accordance with various aspects of the disclosure.

### DETAILED DESCRIPTION

The following description of the embodiments is merely exemplary in nature and is in no way intended to limit the subject matter of the present disclosure, their application, or uses.

As used throughout, ranges are used as shorthand for describing each and every value that is within the range. Any value within the range can be selected as the terminus of the range. Unless otherwise specified, all percentages and amounts expressed herein and elsewhere in the specification should be understood to refer to percentages by weight.

For the purposes of this specification and appended claims, unless otherwise indicated, all numbers expressing quantities, percentages or proportions, and other numerical values used in the specification and claims, are to be understood as being modified in all instances by the term “about.” The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent, alternatively ±5 percent, alternatively ±1 percent, alternatively ±0.5 percent, and alternatively ±0.1 percent of the given numeric value provided such a deviation does not alter the end function or result of the value. Accordingly, unless indicated to the contrary, the numerical parameters set forth in this specification and attached claims are approximations that can vary depending upon the desired properties sought to be obtained by the present invention.

It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

As used herein, the terms “process system” and “reactor system” are used interchangeably, and generally mean a system containing at least one reactor vessel and process equipment. As used herein, the term “process equipment” means any component of a process or reactor system, including but not limited to piping, heat exchangers, fire heaters, drums, towers, pumps, and so on.

Various aspects of the present disclosure are directed to methods for safely removing metal sulfides from catalyst beds in reactor vessels. In accordance with various methods of the disclosure, metal sulfides are converted to metal oxides and gaseous and liquid by-products, and subsequent safe removal of said gaseous and liquid by-products from reactor vessels allows for safe entry into reactor vessels by technicians.

Various aspects of the present disclosure are directed to methods for the safe elimination of sulfides and metal sulfide compounds present in process equipment via oxidative neutralization. The neutralization of sulfide and metal sulfide deposits eliminates the potential to form polythionic acids on process equipment surfaces, particularly sensitized stainless steels. The elimination of polythionic acid formation in turn eliminates the potential for polythionic acid stress corrosion cracking (PASCC) mechanisms on process equipment. This allows for preservation of mechanical integrity and safe maintenance and operation of process equipment.

Various aspects of the present disclosure are directed to methods for the safe elimination/mitigation of components with the potential to form chloride acids on process equipment surfaces, particularly sensitized stainless steels. Mitigation is accomplished via elimination of halide such as chloride containing compounds and neutralization of acidic components via flushing with an alkaline buffered solution. The elimination of halides such as chloride acid formation in turn eliminates the potential for halide and chloride stress corrosion cracking (ClSCC) mechanisms on process equipment. This allows for preservation of mechanical integrity and safe maintenance and operation of process equipment.

Metal catalysts are used in various applications in the refining and petrochemical industries including desulfurization reactions, denitrification reactions, and deoxygenation reactions; hydrogen saturation of olefins and aromatics; hydrocracking reactions; and other selective hydrogenation functions. Over time, the catalysts suffer from decreased efficiencies due to, among other things, conversion to catalytically inactive metal sulfides and coating with coke, volatile aromatic compounds (VOCs) and other heavy aromatics. As discussed above, the presence of metal sulfides in reactor vessels creates not only safety hazards, but also logistical and environmental issues, for companies and employees who are required to clean said vessels and re-load them with fresh catalysts. The present invention is directed to methods for safely removing metal sulfides from catalyst beds in reactor vessels, addressing this long-standing problem.

Current Industry recommended best practices regarding ClSCC and PASCC include a range of treatments aimed at simply mitigating the formation of acids and or neutralizing acids formed from halides and sulfides present in these systems during maintenance activities. Current best practices include oxygen exclusion by inerting, purging systems with dried air, and passivation via the deposition of a neutralizing salt solutions on materials surfaces via filling and soaking. While these mitigation steps can be effectively managed, ClSCC and PASCC remain common industry failure mechanisms resulting in lost opportunity costs as well as loss of containment. The present invention eliminates the components with potential to form these acids, superseding current industry best practices which only offer mechanisms to mitigate the corrosion.

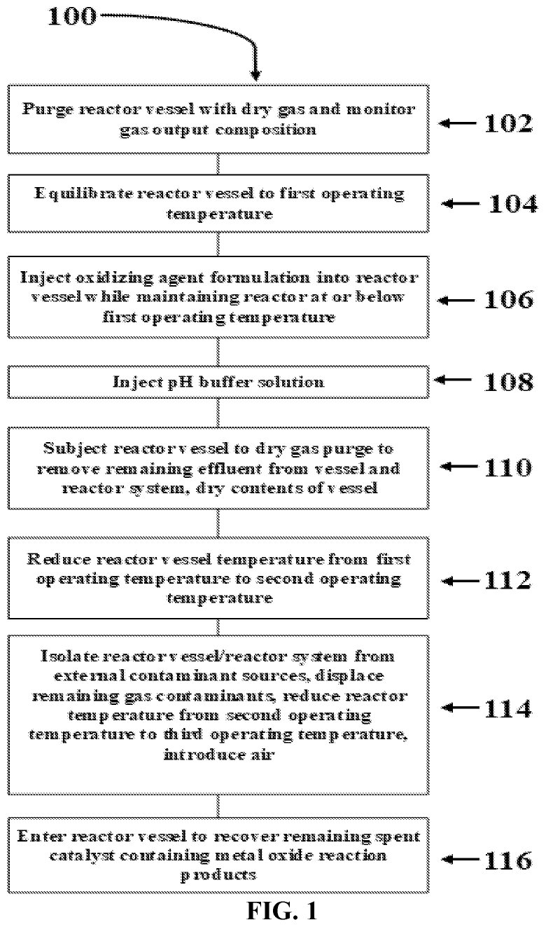

In accordance with various aspects of the present disclosure, the metal sulfides of a spent catalyst, metal sulfide deposits, and sulfide scale formations may be converted to metal oxides and gaseous and liquid by-products via methods that include the injection of an oxidizing agent formulation comprising an oxidizing agent into a reactor vessel containing the spent catalyst and process equipment containing sulfide compounds. Halide compounds in the process system are flushed from the system with an alkaline oxidizing solution and remain neutralized by a buffered solution. Injection methods can be performed according to the schematic flowchart of FIG. 1.

In the injection method 100 of FIG. 1, a series of steps are described. Although specific steps are described in the method 100, in some instances, methods according to the disclosure for the conversion of metal sulfides of a spent catalyst and metal sulfide compounds present in process equipment via injection methods may have more or less steps than the described steps without departing from the scope of the disclosure. According to various aspects of the disclosure, the method 100 can start at step 102.

In step 102, a reactor vessel having metal sulfide-containing spent catalyst contained therein and associated process equipment containing potential halide and sulfide compounds is purged with a dry gas by introducing and or maintaining a pre-existing dry gas purge stream to the vessel via a gas inlet, circulating the gas through the reactor vessel and associated equipment, and allowing to exit the reactor vessel via a fluid outlet. In general, the dry gas will be hydrogen, treat hydrogen (defined as the typical recycle or treat hydrogen stream supplied to the reactor during normal operation of the process unit), nitrogen, methane, ethane, carbon dioxide, refinery or manufacturing complex fuel gas (defined as the combustion gas supply typical of the manufacturing complex for fired heaters and boilers), city gas (defined as the combustion gas supply typical of the manufacturing complex for fired heaters and boilers sourced from a utility supply company), and/or a mixture of these component gases containing no oxygen. During this dry gas purging step 102, the off-gas exiting the fluid outlet can be monitored for composition.

In some instances, the purging of step 102 can be performed using steam instead of a dry gas. In some instances, the purging of step 102 can be performed using water or a suitable aqueous solution instead of a dry gas. The spent catalyst can be a completely spent catalyst (i.e., a catalyst having no remaining catalytic activity) or a partially spent catalyst (i.e., a catalyst having a reduced catalytic activity relative to the catalyst in pristine form).

When a dry gas is used in this purge step, once the gas purge is established and the oxygen content of the dry gas supply and subsequent off-gas contains a sufficiently low oxygen concentration (for example, less than about 2%), the method 100 proceeds to step 104.

In step 104, the reactor vessel is heated to, cooled to, or maintained at a predetermined first operating temperature depending on the pre-existing operating temperature of the vessel. The first operating temperature can vary based upon numerous factors including, but not limited to, the type and amount of metal sulfides within the reactor vessel, the relative strength of the oxidizing agent, the concentration of the oxidizing agent formulation, the concentration of various components in the purge gas stream, the system operating pressure, and so on. In general, the first operating temperature will be between about 50° F. and about 325° F. In some instances, the first operating temperature will be between about 75° F. and about 315° F., alternatively between about 100° F. and about 310° F., alternatively between about 125° F. and about 300° F., alternatively between about 175° F. and about 290° F., alternatively between about 200° F. and about 280° F., alternatively between about 225° F. and about 275° F., and alternatively between about 240° F. and about 260° F. Preferably, the first operating temperature will be about 250° F. Once the reactor vessel has reached the first operating temperature or about the first operating temperature, the method 100 proceeds to step 106. Preferably, the method 100 proceeds to step 106 when the reactor vessel has been equilibrated to the first operating temperature.

In step 106, the oxidizing agent formulation is injected into the reactor vessel. In some instances, the oxidizing agent can be injected directly into the reactor vessel. In some instances, the oxidizing agent can be injected indirectly into the reactor vessel, by injecting the oxidizing agent into a component of reactor system that is upstream of the reactor vessel and directly or indirectly fluidically coupled with the reactor vessel. The formulation can be directly or indirectly injected continuously, incrementally or variably over a predetermined period of time. Injecting the formulation continuously over a period of time means injecting the same or about the same volume of formulation per unit of time during the predetermined injection time period of step 106. Injecting the formulation incrementally over a period of time means injecting the same or about the same volume of formulation during predetermined increments during the predetermined injection time period of step 106. Injecting the formulation variably over a period of time means injecting increasing or decreasing volumes, or combinations thereof, of formulation per unit of time during the predetermined injection time period of step 106. During the injection period of step 106, purging of the reactor vessel with any one of the dry gas, steam or water can be continued. Dispersion of the oxidizing agent formulation across the entirety of the spent catalyst materials will be aided by the vessel internals, tortuous pathways created by the catalyst bed and foaming actions of the formulation components.

Also during the injection period of step 106, the temperature of the reactor vessel can be monitored to optionally maintain the reactor vessel at the predetermined first operating temperature or at about the predetermined first operating temperature. If during step 106, the temperature of the reactor vessel is lowered below the predetermine first operating temperature, the vessel may be heated to raise the temperature to or at about the predetermined first operating temperature. If during step 106, the temperature of the reactor vessel begins to rise, remedial actions may need to be taken in some instances to ensure that an uncontrolled self-propagating exothermic reaction does not ensue. Remedial actions may include, but are not limited to, slowing or stopping the injection of the oxidizing agent formulation into the reactor vessel, injecting cooled water into the reactor vessel, externally cooling the reactor vessel, increasing the purge rate of the dry gas, or any combination thereof for a required period of time during step 106.

Also during step 106, off-gases and liquid effluent from the reactor vessel are allowed to exit the reactor vessel via the fluid outlet and are transmitted to the inlet of a condenser unit. The condenser unit comprises a gas outlet and an effluent containment vessel. Off-gases are cooled in the condenser unit and a portion of the off-gases, which may include, for example, hydrocarbons and water, condense and settle in the effluent containment vessel. Another portion of the off-gases, which may include, for example, VOC's, H₂S, SO₂, CO, and CO₂, will remain a gas and exit the gas outlet of the condenser unit. The type and/or volume of the gases that exit the gas outlet of the condenser unit are monitored during step 106. The process liquid effluent is also sampled at routine intervals and tested to monitor readings which indicate oxidizing solution performance including sulfide compounds, nitrogen compounds, pH, and reaction byproducts. The equipment used for off gas and effluent cooling and separation can vary widely in number of condensing heat exchangers and design of condensing units as well as number of and design of effluent separation and containment vessels depending on the physical configuration of the process unit and or design of the system required to carry out this procedure in accordance with general process design methods.

After a required amount of oxidizing agent formulation has been injected into the reactor vessel and associated reactor system components, or it is established that the oxidation reactions have completed and/or no more reaction product gases and liquid compounds (for example, H₂S, SO₂) are being formed (as evidenced by the type and/or volume of the gases and effluent stream properties that exit the gas and liquid outlets of the condenser unit), the method 100 proceeds to step 108.

In step 108 a pH buffering solution is injected into the reactor vessel and associated system equipment to flush the system of reaction byproducts and provide the system with a neutral pH for safe maintenance work. The pH buffering solution is injected in the same fashion as the oxidizing agent solution and the process effluent monitored for pH and reaction byproducts. Once the system pH achieves the specified target, method 100 proceeds to step 110. In some instances, step 108 is omitted and instead step 110 is performed after step 106.

Step 110 can be conducted at or about at the predetermined first operating temperature. Preferably, step 110 is conducted at or about at the predetermined first operating temperature. In step 110, the reactor vessel and remaining contents are subjected to a continued dry gas purge. The continued dry gas purge is performed to remove remaining formulation components from the reactor vessel and dry the remaining contents. The remaining formulation components, in the form of liquid, gas or a vapor, exits the reaction vessel via the fluid outlet and enters the condenser unit, where it is condensed and collected in the containment effluent vessel or, optionally, in a secondary liquid effluent containment vessel coupled with a second fluid outlet of the condenser unit. Step 110 can be performed, until a specified amount of liquid is produced within the containment effluent vessel or the secondary liquid effluent containment vessel, until liquid is no longer produced within the containment effluent vessel or the secondary liquid effluent containment vessel, or for a desired period of time after liquid is no longer produced within the containment effluent vessel or the secondary liquid effluent containment vessel. Upon the completion of step 110, the method 100 proceeds to step 112.

In step 112, the temperature of the reactor vessel is set to a second operating temperature or about a second operating temperature. In preferred embodiments, the temperature of the reactor vessel is reduced from the first operating temperature to a second operating temperature. In general, the second operating temperature will be between about 32° F. and about 200° F. In some instances, the second operating temperature will be between about 40° F. and about 180° F., alternatively between about 50° F. and about 160° F., alternatively between about 60° F. and about 140° F., and alternatively between about 80° F. and about 120° F. Preferably, the second operating temperature is about 100° F. After completion of step 112, the method 100 proceeds to step 114.

In step 114, the reactor vessel atmosphere is or confirmed to be converted to an inert atmosphere, free of flammable and noxious gases via standard industry methods using commonly applied inert gases. Commonly applied inert gases include, but are not limited to, nitrogen. The reactor vessel and associated system components are isolated from external contaminant sources via standard industry isolation practices. Once the reactor vessel is verified to meet the atmospheric conditions required by industry practices to allow opening flanges and connections, the vessel is positively isolated using blanking, blinding, or equivalent methods. Upon completion of positive isolation, the reactor vessel is opened and an air is allowed to enter the vessel and associated equipment. During the introduction of air, the temperature of the remaining contents of the reactor vessel are monitored to ensure a third operating temperature of about 35° F. to about 150° F. is maintained, alternatively from about 40° F. to about 140° F., alternatively from about 45° F. to about 130° F., and alternatively from about 50° F. to about 120° F., alternatively from about 60° F. to about 110° F., and alternatively from about 80° F. to about 110° F. Preferably, the third operating temperature is about 100° F.

During the air introduction step 114, the reactor vessel temperature is monitored for run/walk away conditions. As referred to herein, run/walk away conditions are defined by an uncontrolled increase in operating temperature above the target operating temperature which will progress to an unsafe operating range without external intervention. Run away conditions refers to rapid increases in temperature, while walk away conditions refers to a slower increase in temperature; both are uncontrolled events. Also during the air introduction step 114, the type and/or volume of off-gases are monitored. The type of off-gases monitored can be products of combustion, such as for example metal sulfides combustion products. If during the air introduction step 114, combustion products are detected and/or reactor temperatures begin to climb in manner evidencing an uncontrolled self-propagating exothermic reaction, step 114 can include terminating the air introduction and reinstating an inert gas purge and/or externally cooling the reactor. In some instances, the second operating temperature of step 112 and the third operating temperature of step 114 are the same. Generally, transition from the second operating temperature to the third operating temperature is achieved merely due to the opening of reactor vessel and entry of air into the vessel.

After completion of step 114, the method 100 proceeds to step 116.

In step 116, entry into the reactor vessel is made by technicians to recover spent catalysts containing metal oxides produced by the method 100 for disposal, future use and/or recycling, and for preparation of the reactor vessel for placement of fresh metal catalyst therein using standard industry methods. Further in step 116, technicians can proceed with maintenance activities on the associated reactor system equipment under normal conditions without inert purging requirements.

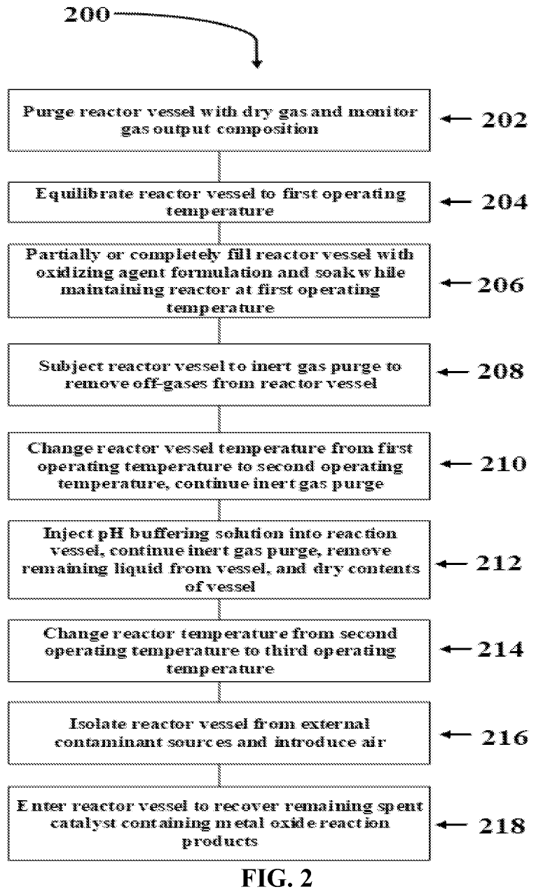

In accordance with various aspects of the present disclosure, the metal sulfides of a spent catalyst, metal sulfide deposits, and sulfide scale formations may be converted to metal oxides and gaseous and liquid by-products via fill-and-soak methods comprising partially or completely filling a reactor vessel containing spent catalyst and process equipment containing sulfide compounds with an formulation comprising an oxidizing agent and holding or circulating the formulation within the reactor vessel for a period of time for metal sulfide to metal oxide conversion to reach a desired level of completion. Halide compounds in the process system are flushed from the system with an alkaline oxidizing solution and remain neutralized by a buffered solution. Fill-and-soak methods can be performed according to the following schematic flowchart of FIG. 2.

In the fill-and-soak method 200 of FIG. 2, a series of steps are described. Although specific steps are described in the method 200, in some instances, methods according to the disclosure for the conversion of metal sulfides of a spent catalyst via fill-and-soak methods may have more or less steps than the described steps without departing from the scope of the disclosure. According to various aspects of the disclosure, the method 200 can start at step 202.

In step 202, a reactor vessel having metal sulfide-containing spent catalyst contained therein and associated process equipment containing potential halide and sulfide compounds is purged with a dry gas by introducing and or maintaining a pre-existing dry gas purge stream to the vessel via a gas inlet, circulating the gas through the reactor vessel and associated equipment, and allowing to exit the reactor vessel via a gas outlet. In general, the dry gas will be hydrogen, treat hydrogen (defined as the typical recycle or treat hydrogen stream supplied to the reactor during normal operation of the process unit), nitrogen, methane, ethane, carbon dioxide, refinery or manufacturing complex fuel gas (defined as the combustion gas supply typical of the manufacturing complex for fired heaters and boilers), city gas (defined as the combustion gas supply typical of the manufacturing complex for fired heaters and boilers sourced from a utility supply company), and/or a mixture of these component gases containing no oxygen.

In some instances, the purging of step 202 can be performed using steam instead of a dry gas. In some instances, the purging of step 202 can be performed using water or a suitable aqueous solution instead of a dry gas. The spent catalyst can be a completely spent catalyst (i.e., a catalyst having no remaining catalytic activity) or a partially spent catalyst (i.e., a catalyst having a reduced catalytic activity relative to the catalyst in pristine form).

During this purging step 202, the off-gas exiting the gas outlet can be monitored for oxygen content. When a dry gas is used in this purge step, once the gas purge is established and the oxygen content of the gas supply and subsequent off-gas contains a sufficiently low oxygen concentration (for example, less than about 2%), the method 200 proceeds to step 204.

In step 204, the reactor vessel is heated to, cooled to, or maintained at a predetermined first operating temperature depending on the pre-existing operating temperature of the vessel. The first operating temperature can vary based upon numerous factors including, but not limited to, the type and amount of metal sulfides within the reactor vessel and associated process equipment in scope, the relative strength of the oxidizing agent, the concentration of the oxidizing agent formulation and so on. In general, the first operating temperature will be between about 50° F. and about 325° F. In some instances, the first operating temperature will be between about 55° F. and about 300° F., alternatively between about 60° F. and about 275° F., alternatively between about 65° F. and about 250° F., alternatively between about 70° F. and about 225° F., alternatively between about 75° F. and about 200° F., alternatively between about 80° F. and about 175° F., alternatively between about 85° F. and about 150° F., alternatively between about 90° F. and about 125° F., and alternatively between about 95° F. and about 105° F. Preferably, the first operating temperature is about 100° F.

In some instances, the purge described step 202 can be continually or intermittently maintained during step 204. Once the reactor vessel has reached the first operating temperature or about the first operating temperature, the method 200 proceeds to step 206. Preferably, the method 200 proceeds to step 206 when the reactor vessel has been equilibrated to the first operating temperature.

In step 206, the oxidizing agent formulation is injected into the reactor vessel to partially or completely fill the reactor vessel and associated equipment in the scope of work. In some instances, the oxidizing agent can be injected directly into the reactor vessel. In some instances, the oxidizing agent can be injected indirectly into the reactor vessel, by injecting the oxidizing agent into a component of reactor system that is upstream of the reactor vessel and directly or indirectly fluidically coupled with the reactor vessel. The formulation can be directly or indirectly injected continuously, incrementally or variably over a predetermined period of time. Injecting the formulation continuously over a period of time means injecting the same or about the same volume of formulation per unit of time during the predetermined injection time period of step 206. Injecting the formulation incrementally over a period of time means injecting the same or about the same volume of formulation during predetermined increments during the predetermined injection time period of step 206. Injecting the formulation variably over a period of time means injecting increasing or decreasing volumes, or combinations thereof, of formulation per unit of time during the predetermined injection time period of step 206. In some instances, the formulation can be injected from the bottom of the vessel until completely full as identified via a vent location positioned at the top of the vessel. In some instances, the formulation may be injected from the top of the vessel to a drain location positioned at the bottom of the vessel where by the vessel will be completely filled. When injecting formulation from the top of the vessel down, dispersion of the oxidizing agent formulation across the entirety of the spent catalyst bed will be aided by the vessel internals, tortuous pathways created by the catalyst bed and a foaming action of the formulation components.

Once the reactor vessel and associated equipment in the scope of work have been partially or completely filled with the oxidizing agent formulation, the formulation will be recirculated or maintained within the reactor vessel for a period of time (the “soak” period). During the soak period, the metal sulfide in the spent catalyst reacts with the oxidizing agent.

During the fill-and-soak step 206, the temperature of the reactor vessel can be monitored to optionally maintain the reactor vessel at the predetermined first operating temperature or at about the predetermined first operating temperature. If during step 206, the temperature of the reactor vessel is lowered below the predetermined first operating temperature, the vessel may be heated to raise the temperature to or substantially to the predetermined first operating temperature. If during step 106, the temperature of the reactor vessel begins to rise, remedial actions may need to be taken in some instances to ensure that an uncontrolled self-propagating exothermic reaction does not ensue. Remedial actions may include, but are not limited to, slowing or stopping the injection of the oxidizing agent formulation into the reactor vessel, injecting cooled water into the reactor vessel, externally cooling the reactor vessel, purging the reactor vessel with an inert gas and releasing off-gases from the reactor vessel via the gas outlet, or any combination thereof during step 206.

In some instances, the purge described in step 202 can be continually or intermittently performed during step 206. After the fill-and-soak process of step 206 has been completed, the method 200 proceeds to step 208.

In step 208, with inert gas purging, off-gases from the reactor vessel are allowed to exit the reactor vessel via the gas outlet and are transmitted to a gas inlet of a condenser unit. The condenser unit comprises a gas outlet and an effluent containment vessel. Off-gases are cooled in the condenser unit and a portion of the off-gases, which may include, for example, VOC's and water, condense and settle in the effluent containment vessel. Another portion of the off-gases, which may include, for example, H₂S, SO₂, CO, and CO₂, will remain a gas and exit the gas outlet of the condenser unit. The type and/or volume of the gases that exit the gas outlet of the condenser unit are monitored during step 208.

In some instances, the dry gas purge described in step 202 can be continually or intermittently performed during step 208. After it is established that the oxidation reactions have completed and/or no more reaction product gases and liquid compounds (for example, H₂S, SO₂) are being produced and/or removed from the reactor vessel (as evidenced by the type and/or volume of the gases that exit the gas and effluent stream properties outlets of the condenser unit), the method 200 proceeds to step 210.

In step 210 the temperature of the reactor vessel is set to a second operating temperature or about a second operating temperature. In some instances, the temperature of the reactor vessel is adjusted from the first operating temperature to a second operating temperature. In general, the second operating temperature will be between about 50° F. and about 250° F. In some instances, the second operating temperature will be between about 100° F. and about 240° F., alternatively between about 150° F. and about 230° F., alternatively between about 175° F. and about 220° F., alternatively between about 190° F. and about 210° F., and alternatively between about 195° F. and about 205° F. Preferably, the second operating temperature will be about 200° F. In step 210, the remaining oxidizing agent formulation is removed from the reactor vessel. In some instances, the and remaining contents may be subjected to a continued inert gas purge. In some instances, the remaining contents are subjected to a continued inert gas purge. Upon the completion of step 210, the method 210 proceeds to step 212. In some instances, step 210 can be omitted and instead step 212 is performed after step 208.

In step 212 a pH buffering solution is injected into the reactor vessel and associated system equipment to flush the system of reaction byproducts and prepare the system with a neutral pH for safe maintenance work. The pH buffering solution is injected in the same fashion as the oxidizing agent solution and the process effluent monitored for pH and reaction byproducts. The continued inert gas purge is performed to remove remaining liquid from the reaction vessel, and dry the remaining contents. The remaining liquid, in the form of gas or a vapor, exits the reaction vessel via the gas outlet and enter the condenser unit, where it is condensed and collect in the containment effluent vessel or, optionally, in a secondary liquid effluent containment vessel coupled with a second gas outlet of the condenser unit. Step 208 can be performed until liquid is no longer produced within the containment effluent vessel or the secondary liquid effluent containment vessel, or for a desired period of time after liquid is no longer produced within the containment effluent vessel or the secondary liquid effluent containment vessel.

During the fill-and-soak step 212, the temperature of the reactor vessel can be monitored to optionally maintain the reactor vessel at the predetermined first operating temperature or at about the predetermined first operating temperature. If during step 212, the temperature of the reactor vessel is lowered below the predetermined first operating temperature, the vessel may be heated to raise the temperature to or substantially to the predetermined first operating temperature. If during step 212, the temperature of the reactor vessel begins to rise, remedial actions may need to be taken in some instances to ensure that an uncontrolled self-propagating exothermic reaction does not ensue. Remedial actions may include, but are not limited to, slowing or stopping the injection of pH buffering solution into the reactor vessel, injecting cooled water into the reactor vessel, externally cooling the reactor vessel, purging the reactor vessel with an inert gas and releasing off-gases from the reactor vessel via the gas outlet, or any combination thereof during step 212.

Once the system pH achieves the specified target method 200 proceeds to step 214. In some instances, step 212 can be omitted and instead step 214 is performed after step 210.

In step 214, the temperature of the reactor vessel is set to a third operating temperature. Using an inert gas purge, the temperature of the remaining contents of the reactor vessel are cooled to the third operating temperature of about 50° F. to about 150° F., alternatively from about 60° F. to about 140° F., alternatively from about 70° F. to about 130° F., alternatively from about 80° F. to about 120° F., alternatively from about 90° F. to about 110° F., and alternatively from about 95° F. to about 105° F. Preferably, the third operating temperature will be about 100° F. After completion of step 212, the method 200 proceeds to step 216.

In step 216, once the reactor vessel and associated equipment is verified to meet the atmospheric conditions required by industry practices to allow opening flanges and connections, the vessel is positively isolated using blanking, blinding, or equivalent methods. Upon completion of positive isolation, the reactor vessel is opened and an air introduction is performed. During the air introduction the temperature of the remaining contents of the reactor vessel is maintained at or about the third operating temperature.

During the air introduction step 216, the reactor vessel temperature can monitored for run/walk away conditions. Also during the air introduction step 216, the type and/or volume of off-gases can be monitored. The type of off-gases monitored can be products of combustion, such as for example metal sulfides combustion products. If during the air introduction step 216, combustion products are detected and/or reactor temperatures begin to climb in manner evidencing an uncontrolled self-propagating exothermic reaction, step 216 can include terminating the air introduction and reinstating an inert gas purge and/or externally cooling the reactor.

After completion of step 216, the method 200 proceeds to step 218.

In step 218, entry into the reactor vessel is made by technicians to recover spent catalysts containing metal oxides produced by the method 200 for, disposal, future use and/or recycling, and for preparation of the reactor vessel for placement of fresh metal catalyst therein using standard industry methods. Further in step 218, technicians can proceed with maintenance activities on the associated reactor system equipment under normal conditions without inert purging requirements.

According to various aspects of method 100 or method 200, the oxidizing agent formulation can take various forms. In some instances, the oxidizing agent formulation can comprise one or more oxidizing agents dissolved or dispersed in water. In this instance, the oxidizing agent formulation can be referred to as an aqueous oxidizing agent solution. In some instances, the oxidizing agent formulation can comprise one or more oxidizing agents dissolved or dispersed in an organic solvent. In this instance, the oxidizing agent formulation can be referred to as an organic oxidizing agent solution. Oxidizing agent solutions, whether aqueous or organic, can have an oxidizing agent concentration ranging from about 1 wt % to about 50 wt %, alternatively from about 2.5 wt % to about 40 wt %, alternatively from about 3 wt % to about 30 wt %, alternatively from about 4 wt % to about 25 wt %, and alternatively from about 5 wt % to about 20 wt %. In some instances, a formulation having about 5 wt % oxidizing agent can be used. In some instances, a formulation having about 10 wt % oxidizing agent can be used. In some instances, a formulation having about 20 wt % oxidizing agent can be used. In some instances, oxidizing agents formulations in the form of solutions can be prepared prior to injection within a reactor vessel. In some instances, oxidizing agents formulations and pH buffering in the form of solutions can be prepared within the reactor vessel itself by separate addition of oxidizing agent(s) and solvent (aqueous or organic).

In some instances, the amount of oxidizing agent used can be less than a stoichiometric amount relative to the amount of metal sulfides in the reactor vessel and associated equipment. In some instances, the amount of oxidizing agent used can be a stoichiometric amount relative to the amount of metal sulfides in the reactor vessel and associated equipment. In some instances, the amount of oxidizing agent used can be in a stoichiometric excess relative to the amount of metal sulfides in the reactor vessel and associated equipment. In some instances, the amount of oxidizing agent used can be a stoichiometric amount that is about 80% to about 120% relative to the amount of metal sulfides in the reactor vessel and associated equipment. In some instances, the amount of oxidizing agent used can be a stoichiometric amount that is about 85% to about 115% relative to the amount of metal sulfides in the reactor vessel and associated equipment. In some instances, the amount of oxidizing agent used can be a stoichiometric amount that is about 90% to about 110% relative to the amount of metal sulfides in the reactor vessel and associated equipment. In some instances, the amount of oxidizing agent used can be a stoichiometric amount that is about 95% to about 105% relative to the amount of metal sulfides in the reactor vessel and associated equipment.

According to various aspects of the present disclosure, a number of oxidizing agents can be used. In some instances, the oxidizing agent formulation can have one oxidizing agent. In some instances, the oxidizing agent formulation can have more than one oxidizing agent. In some instances, suitable classes of oxidizing agents include, but are not limited to amine oxides, brominated compounds, hypervalent bromine compounds, bromates, chlorinated compounds, chlorates, chromates, dichromates, chromium compounds, halogens (bromine, chlorine and iodine), hypochlorites, iodates, iron(II) compounds, iron (III) compounds, iron (IV) compounds, manganese compounds, molybdenum compounds, nitrites, nitrates, perborates, perchlorates, periodates, permanganates, peroxides (such as hydroperoxides, inorganic peroxides, ketone peroxides), peroxyacids, persulfides, quinones, rhenium compounds, ruthenium (III) compounds, ruthenium (IV) compounds, ruthenium (V) compounds, ruthenium (VI) compounds, ruthenium (VII) compounds, and vanadium compounds.

In some instances, specific oxidizing agents include, but are not limited to, acetone, acrylonitrile, ammonium cerium (IV) nitrate, ammonium peroxydisulfate, 2-azaadamantane-N-oxyl (AZADO), 1-methyl-2-azaadamantane-N-oxyl (1-Me-AZADO), 2-azanoradamantane-N-oxyl (Nor-AZADO), 9-azabicyclo[3.3.1]nonane N-oxyl (ABNO), 1,4-benzoquinone, benzaldehyde, benzoyl peroxide, bleach, N-bromosaccharin, N-bromosuccinimide, Burgess reagent, N-tert-butylbenzenesulfinimidoyl chloride, nitric acid, perchloric acid, chlorinated isocyanurates, tert-butyl hydroperoxide, tert-butyl hypochlorite, tert-butyl nitrite, tert-butyl peroxybenzoate, carbon tetrabromide, choline peroxydisulfate (ChPS), chloramine-B, chloramine-T, chloranil, N-chlorobenzenesulfonamide sodium salt, chloromethyl-4-fluoro-1,4-diazoniabicyclo[2.2.2]octane bis(tetrafluoroborate), N-chlorotosylamide sodium salt, 3-chloroperoxybenzoic acid (MCPBA), N-chlorosuccinimide, chromium trioxide, Collins reagent, Corey-Suggs reagent, cumene hydroperoxide (CMHP), crotonitrile, 1,3-dibromo-5,5-dimethylhydantoin (DBDMH), 1,3-dichloro-5,5-dimethylhydantoin (DCDMH), 1,3-diiodo-5,5-dimethylhydantoin (DIH), dicumyl peroxide (DCP), 4,5-dichloro-3,6-dioxo-1,4-cyclohexadiene-1,2-dicarbonitrile (DDQ), 1,2-ethoxycarbonyl diazene (DEAD), diethyl allyl phosphate(DEAP), Dess-Martin periodinane (DMP), diisopropyl azodiformate (DIAD), bis(4-chlorobenzyl)azodicarboxylate (DCAD), 2,3-dichloro-5,6-dicyanobenzoquinone, diethyl azodicarboxylate, dimethyl sulfoxide (DMSO), di-tert-butyl peroxide (DTBP), tert-butyl hydroperoxide (TBHP), tert-butyl hypochlorite, 3,4-dihydro-5-[4-(1-piperidinyl)butoxyl]-1(2H)-isoquinolinone (DPQ), (E)-but-2-enenitrile, ferric chloride, ferric nitrate, N-fluorobenzenesulfonimide, N-fluoropyridinium triflate, N-fluoro-2,4,6-trimethylpyridinium triflate, formic acid, hydrogen peroxide, hydrogen peroxide urea adduct (UHP), 2-hydroperoxy-4,6-diphenyl-1,3,5-triazine, [hydroxy(tosyloxy)iodo]benzene (HTIB), 2-iodoxybenzoic acid (IBX), iodine pentoxide, iodobenzene dichloride, iodobenzene diacetate, iodosobenzene bis(trifluoroacetate), N-iodosuccinimide, 2-iodoxybenzoic acid, Jones reagent, Koser's reagent, lauryldimethylamine oxide (LDAO), magnesium monoperoxyphthalate hexahydrate, manganese(IV) oxide, (methoxycarbonylsulfamoyl)triethylammonium hydroxide, N-methylmorpholine-N-oxide (NMO), methyltrioxorhenium (MTO), N,N,N′,N′-tetrachlorobenzene-1,3-disulfonamide (TCBDA), nitric acid, tert-butyl nitrite nitrosobenzene, osmium tetroxide, oxalyl chloride, oxone, perchloric acid, pyridinium chlorochromate (PCC), pyridinium chlorochromate (PDC), peracetic acid, periodic acid, phenyliodonium diacetate, phthaloyl peroxide, [bis(trifluoroacetoxy)iodo]benzene (PIFA), pivaldehyde, potassium ferricyanide, potassium permanganate, potassium peroxydisulfate, potassium peroxomonosulfate, 2,5-diphenyloxazole (PPO), 2-propanone, pyridine N-oxide, pyridinium hydrobromide perbromide, pyridinium chlorochromate, pyridinium dichromate, pyridinium tribromide, Sarett reagent, 1-chloromethyl-4-fluoro-1,4-diazoniabicyclo[2.2.2]octane bis(tetrafluoroborate) (Selectfluor), selenium dioxide, sodium bromate, sodium chlorate, sodium dichloroiodate, sodium hypochlorite, sodium nitrite, sodium percarbonate, sodium periodate, sodium peroxydisulfate, sulfur, styrene, tetrabromocinnamic acid (TBCA), tert-butyl nitrite (TBN), tert-butyl peroxybenzoate (TBPB), trichloroisocyanuric acid (TCCA), (2,2,6,6-Tetramethylpiperidin-1-yl)oxyl (TEMPO), tetrabromoethane, tetrachloro-1,4-benzoquinone, tetrabutylammonium peroxydisulfate, 2,2,6,6-tetramethylpiperidinyloxy, tetrapropylammonium perruthenate (TPAP), 3,3′,5,5′-tetra-tert-butyldiphenoquinone, triacetoxyperiodinane, 2-hydroperoxy-4,6-diphenyl-1,3,5-triazine (Triazox), tribromoisocyanuric acid, trichloroisocyanuric acid, 1,1,1-trifluoroacetone, trifluoroacetic peracid, and trimethylacetaldehyde.

In some instances, the oxidizing agent formulation preferably includes sodium nitrite. In some instances, the oxidizing agent formulation preferably includes LDAO. In some instances, the oxidizing agent formulation preferably includes a combination of sodium nitrite and LDAO. In some instances, the oxidizing agent formulation preferably includes a combination of major amount sodium nitrite and minor amount of LDAO. Oxidizing agent formulations according to various aspects of the disclosure may be aqueous solutions and can have a sodium nitrite:LDAO (w/w) ratio ranging from about 100:1 to about 1:100, alternatively from about 90:1 to about 1:50, alternatively from about 80:1 to about 1:25, alternatively from about 70:1 to about 1:10, alternatively from about 60:1 to about 1:1, alternatively from about 50:1 to about 2:1, alternatively from about 40:1 to about 3:1, alternatively from about 25:1 to about 4:1, and alternatively from about 15:1 to about 5:1. In the examples below sodium nitrite:LDAO (w/w) ratios of 5:1, 12.5:1 and 40:1 are used.

In some instances, oxidizing agent formulations according to the disclosure can further include a pH buffer. Suitable pH buffers include, but are not limited to monosodium phosphate and disodium phosphate. Using a pH buffer, aqueous oxidizing agent formulations can be prepared to have a pH ranging from about 7 to about 9.5, alternatively from about 8 to about 9.5, alternatively from about 8.25 to about 9.5, alternatively from about 8.5 to about 9.25, and alternatively from about 8.75 to about 9.25. In some instances, aqueous oxidizing agent formulations are prepared with a pH buffer to have a pH of about 9. In general, slightly alkaline aqueous oxidizing agent formulations are preferred.

In some instances, oxidizing agent formulations according to the disclosure can further include one or more water soluble organic solvents. Suitable water soluble organic solvents include, but are not limited to C₁-C₁₂ linear or branched alcohols or diols (for example, ethanol, octanol isopropanol, 1,5-propanediol and 1,4-butanediol), aliphatic and aromatic heterocycles (for example, 1,4-dioxane, pyridine, tetrahydrofuran), ketones (for example acetone), amides (for example, dimethylformamide and N-methyl pyrrolidone), amines (for example, ethylamine, propylamine, diethanolamine, and methylethanolamine), nitriles (for example, acetonitrile) and dimethlysulfoxide.

In some instances oxidizing agent formulations according to the disclosure can further include one or more water soluble surfactants. Suitable water soluble surfactants can include some non-ionic surfactants and some ionic surfactants. In some instances, suitable ionic surfactants include an anionic head group such as a sulfate, and sulfonate, a phosphate or a carbonate. In some instances, suitable ionic surfactants include a cationic head group such as a ammonium, a pyridinium, or a phosphonium. In some instances, suitable ionic surfactants include a zwitterionic head group.

According to various aspects of method 100 or method 200, the pH buffering solution formulation used in step 108 of method 100 or step 212 of method 200 can take various forms. Suitable pH buffers include but are not limited to monosodium, phosphate, disodium phosphate, boric acid, borate, monobasic potassium, dibasic potassium, maleic anhydride, morpholine, phosphoric acid, borate. Using a pH buffer, solutions can be prepared to have a pH ranging from about 6.5 to about 9.5, alternatively from about 6.5 to about 8, alternatively from about 6.5 to about 7.5, alternatively from about 6.5 to about 7.25, and alternatively from about 6.5 to about 7.25. In some instances, pH buffers formulations are prepared to have a pH of about 6.5. In general, high capacity aqueous pH buffering formulations are preferred. As used herein, a high capacity buffering solution is one that can tolerate large volumes of both acids and bases without permitting the pH of the overall solution to differ largely from the target pH. Buffer capacity (β) is defined as the moles of an acid or base necessary to change the pH of a solution by 1, divided by the pH change and the volume of buffer in liters; it is a unitless number. A buffer resists changes in pH due to the addition of an acid or base through consumption of the buffer.

Various metal sulfide-containing spent catalysts can be treated according to various aspects of method 100 or method 200. Metal sulfides that can be converted to metal oxides and gaseous and liquid by-products include, but are not limited to, nickel sulfides, molybdenum sulfides, cobalt sulfides, iron sulfides, copper sulfides, tungsten sulfides, titanium sulfides, manganese sulfides, chromium sulfides, noble metal promoted-molybdenum sulfides, non-noble metal promoted-molybdenum sulfides, zinc sulfides, and lead sulfides.

In methods 100 and 200, the primary objective can be stated as safely removing metal sulfides from catalyst beds in reactor vessels. In some instances, however, methods 100 and 200 can be performed on a reactor system and corresponding reactor vessel(s), where the reactor vessel(s) may or may not include a spent catalyst, for the treatment of components of the reactor system made of austenitic stainless steels. Specifically, the inventors of the application have found treatment methods 100 and 200 enable the oxidation and conversion of sulfide scales on reactor system components (such as piping, heat exchange modules, furnaces, air coolers, and so on) made of sensitized austenitic stainless steels resulting in the elimination of the potential to form polythionic and thionic acids. Additionally, the inventors have found that various halide compounds including, but not limited to, those containing chlorides and chloride salts are removed and treated from reactor system components (such as piping, heat exchange modules, furnaces, air coolers, and so on) made of sensitized austenitic stainless steels using method 100 and method 200. As such, treatment methods 100 and 200 also enable the removal and neutralization of halide compounds on sensitized austenitic stainless steels, resulting in the elimination of the potential to form halide acids.

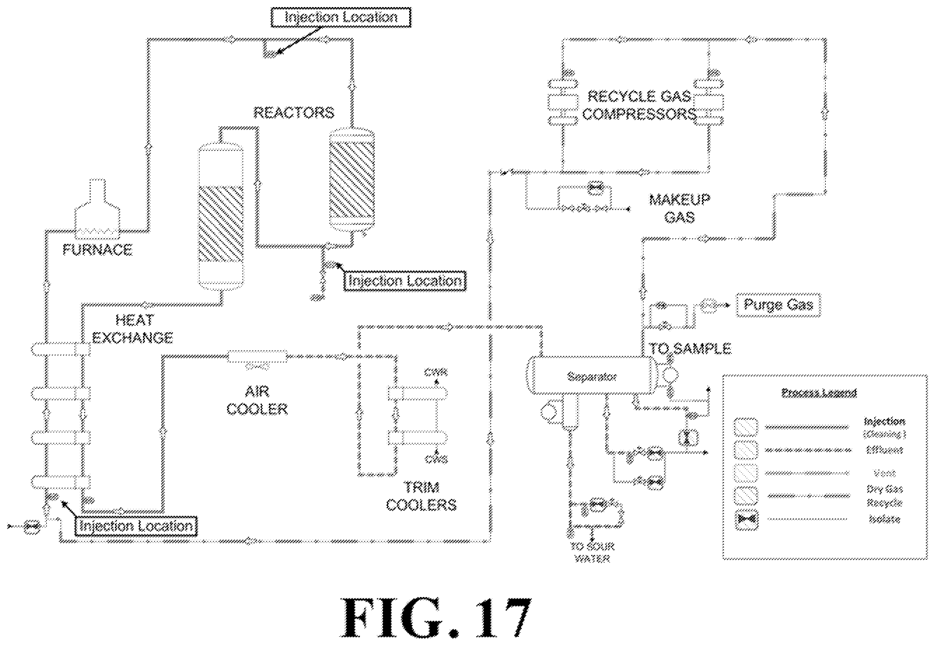

FIG. 17 is a schematic diagram of the commercial reactor system. As shown, the reactor system includes a furnace, heat exchange modules, two reactor vessels and an air cooler connected in series by associated piping on the left-hand side of FIG. 17. A first injection location is located upstream of the heat exchange modules, a second injection location is located upstream of the first reactor vessel, and the third injection location is located upstream of the second reactor vessel. Additional injection locations and/or reactor system components can be present in series on, or connected to, the injection line of FIG. 17 (see process legend). Using injection method 100, dry and inert gases can be introduced to the system from make-up gas sources and or circulated through the process system using the recycle gas compressor as well as or injected into the reactor system via one or more of the injection locations, and oxidizing agent formulations and pH buffering solutions as described herein can be injected into the reactor system via one or more of the injection locations, to treat piping and components of the reactor system made of austenitic stainless steels, where the reactor vessel(s) may or may not include a spent catalyst. Using fill-and-soak method 200, dry and inert gases can be injected into the reactor system via one or more of the injection locations, and oxidizing agent formulations and pH buffering solutions as described herein can be injected into the reactor system via one or more of the injection locations to fill target piping and system components with oxidizing agent formulations and pH buffering solutions followed by soak period(s), to treat piping and components of the reactor system made of austenitic stainless steels, where the reactor vessel(s) may or may not include a spent catalyst. Treatment regimens performed according to the disclosures of this application will oxidize and convert sulfide scales on said austenitic stainless steel components to eliminate potential formation of polythionic and thionic acids, and remove and neutralize halide compounds on said austenitic stainless steels to eliminate the potential to form halide acids.

### EXAMPLES

Methodology. The examples below serve as both a demonstration of oxidation performance and neutralization of self-heating behavior, and as a basis for pilot scale demonstrations of commercial application methods. The testing equipment, apparatus, and operating conditions described below are intended to mimic those observed in commercial operations during catalyst system shutdown and preparation. During normal catalyst system shutdown, the reactor vessel is purged and cleaned of residual hydrocarbons and H₂S using, for example, conventional catalyst bed sweeping/stripping methods. Following the removal of hydrocarbons and H₂S from the catalyst bed, the entire reactor vessel is cooled to acceptable entry temperatures using a combination of sweeping hydrogen and nitrogen streams. It is during this cooling period that the exemplary catalyst oxidation processes via injection into the reactor system are to be performed. In addition to in-situ oxidation during the reactor cooling portion of the shutdown steps, it is notable that the oxidation steps can also occur via isolation of the reactor vessel using a fill and soak method. As described previously, either approach to the oxidation of these catalyst materials prior to removal from the reactor vessel are acceptable strategies and are encompassed by the novel approach to reactive neutralization of the spontaneous reactivity of these spent catalyst materials.

The exemplary catalyst oxidation processes below employ the injection/application of an oxidizer in an aqueous solution to be contacted with the catalyst materials via either a dry gas environment or liquid fill-and-soak methods. Oxidation of metal sulfides present on surfaces of the catalyst materials eliminates the spontaneous reactivity of these spent catalyst materials under standard atmospheric conditions containing oxygen. This results in a treatment by which reactor systems can be transitioned to standard air ventilation for maintenance activities, creating a safer environment for catalyst removal activities as well as improved safety in materials handling and transport of spent catalysts. Specifically, while not limited to the examples, the examples described below show oxidation of spent NiMo hydroprocessing catalyst materials using prepared solutions containing sodium nitrite (NaNO₂) and lauryldimethylamine N-oxide (LDAO) as oxidizing agents.

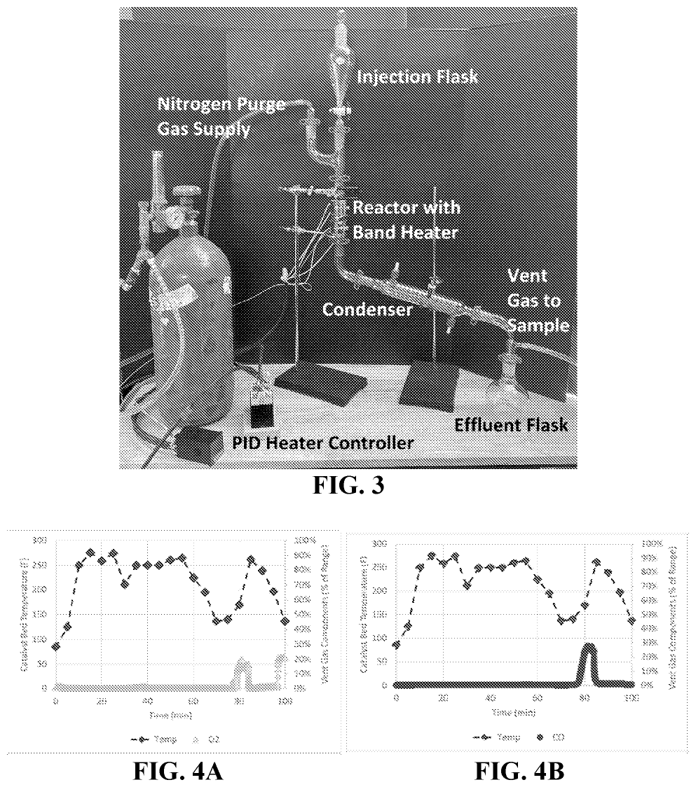

As described in the examples below, oxidation of metal sulfides on spent catalyst materials was accomplished by placing a spent NiMo hydroprocessing catalyst material sample in a catalyst testing apparatus and performing the application of the oxidizing solution under a constant nitrogen purge at a controlled operating temperature. An exemplary, laboratory scale catalyst testing apparatus is shown in FIG. 3. As shown in FIG. 3, the laboratory scale catalyst testing apparatus includes a purge gas (nitrogen) supply and a reagent injection flask coupled with a reactor vessel. Downstream of the reactor vessel is a condenser coupled with an effluent collection flask and a vent for collecting gas produced during use of the apparatus.

The vent gas (of “off-gas”) stream from the reactor was monitored for gaseous oxidation reaction products, liquid or aqueous oxidation reaction products were collected in the effluent collection flask for analysis, and the reactor vessel temperature controlled and monitored by a proportional-integral-derivative (PID) heater controller coupled with a band heater, which is wrapped around the reactor vessel. Following the application of oxidizing solution, the catalyst sample was swept with a hot air stream to monitor for products of combustion, and uncontrolled reactivity. The spent catalyst samples were spent NiMo catalysts sourced from a naphtha hydrotreating unit. The spent catalyst samples contained 2.4 wt % nickel and 13 wt % molybdenum and 20.7 wt % active metal sulfides. The primary oxidizer employed in the treating solutions applied was NaNO₂, resulting in oxidation reactions, as tabulated in Table 1, occurring in the testing apparatus. As can be appreciated, the negative net heat of formation values correspond to exothermic reactions while positive values correspond to endothermic reactions.

TABLE 1

| | Net Heat of |
|---|---|
| Oxidation Reaction | Formation (kJ/mol) |
| 2H₂O + NaNO₂ + 3NiS → NaOH + 3S + 3NiO + | −1.72 |
| NH₃ | |
| 2H₂O + NaNO₂ + 1NiS → NaOH + SO₂ + NiO + | 18.28 |
| NH₃ | |
| 9H₂ + 6NaNO₂ + 4NiS → 6Na + 4NiO + 6NH₃ + | 57.2 |
| 4SO₂ | |
| 7H₂ + 2NaNO₂ + 4NiS → 2Na + 4NiO + 2NH₃ + | −90 |
| 4H₂S | |
| 2H₂O + NaNO₂ + MoS₂ → NaOH + 2S + MoO₃ + | 4.45 |
| NH₃ | |
| 14H₂O + 7NaNO₂ + 3MoS₂ → 7NaOH + 6SO₂ + | 126.47 |
| 3MoO₃ + 7NH₃ | |
| 21H₂ + 14NaNO₂ + 4MoS₂ → 14Na + 4MoO₃ + | 131.48 |
| 14NH₃ + 8SO₂ | |
| 17H₂ + 6NaNO₂ + 4MoS₂ → 6Na + 4MoO₃ + | −162.2 |
| 6NH₃ + 8H₂S | |

The oxidation reactions of Table 1 highlight several products from the oxidation processes that can be easily analyzed off-gases from each reaction vessel purge gas stream. SO₂ and H₂S can be monitored and tracked using standard gas testing equipment as one means to verify the extent of oxidation reactions occurring within the reaction vessel. SO₂ is also a product of combustion reactions that take place spontaneously between metals sulfides and oxygen. By monitoring the product gases released from exposure of spent catalyst materials to oxidizing agents in aqueous solutions under inert conditions as well as when exposed to air for the presence of H₂S and SO₂ it is possible to confirm the catalyst materials can be neutralized and the metal sulfides converted to metal oxides via the application of the aqueous oxidizing agents. The development of the testing procedure highlighted below was the result of extensive experimentation by which the testing apparatus was configured in multiple arrangements for optimal vent gas analysis and collection of process effluent for additional testing. For each of the test results provided, a standardized 30 ml (20 g) sample of spent catalyst material was treated under the premise of four primary conditions: Baseline (no oxidizing agent; only water), limited amounts of oxidizing agent (sub-stoichiometric relative to the amount of metal sulfides in the spent catalyst sample), exact amounts of oxidizing agent (stoichiometric amount relative to the amount of metal sulfides in the spent catalyst sample), and excess amounts of oxidizing agent (relative to the amount of metal sulfides in the spent catalyst sample). Given the known metal sulfides content of the spent catalyst samples and the stoichiometry of the reactions, the concentration of oxidizing agent solution was varied as well as the volume of solution injected to meet the testing objectives.

General Experimental Protocol. The examples below were conducted using the following experimental protocol:

1. Placing a standard 30 ml (20 g) sample of spent catalyst material in the reactor vessel, maintaining an inert atmosphere in the reactor vessel during the sample loading.

2. Filling the injection flask with an oxidation solution.

3. Establishing a nitrogen purge in the reactor vessel and testing apparatus at a rate of 1-2 ft³/hr and verifying, using gas analysis meters, that the oxygen content in the off-gas stream is sufficiently low to confirm an inert purge is maintained. It is recommended to ensure the gas analysis instruments are properly operating and providing accurate readings before continuing.

4. Starting and maintaining the flow of cool water in the effluent condenser(s).

5. Using the external band heater and PID heater controller, heating the outside of the reactor vessel to a target operating temperature, preferably 250° F., and holding the reactor vessel at this temperature until a temperature change is specified in the procedure. Be sure to safely heat the vessel in a controlled manner.

6. When the reactor vessel equilibrates to the target operating temperature, injecting the oxidation solution into the reactor vessel and on the catalyst bed.

7. During the injection step, monitoring the reactor temperature for changes and, if temperature changes occur, adjusting the injection rate of the oxidation solution to maintain the target first operating temperature as closely as feasible.

8. Monitoring the vent off-gas product readings during the injection. When injecting oxidizer into the system a variety of reaction product gases is expected, including SO₂ and H₂S, which serve as markers for verification that the metal sulfides are being oxidized.

9. Upon completion of oxidizing solution injection, continuing to maintain a purge of nitrogen gas through the system, and removing the catalyst of excess water (or “drying” the catalyst). During this time, the outlet of the reactor and condenser inlet can be monitored for the accumulation of condensate.

10. When condensation of water downstream of the reactor reduces/stops, cooling the reactor vessel to less than 200° F. to prepare for a transition from the nitrogen purge to a hot air purge.

11. Once the reactor vessel is cooled, isolating the nitrogen sweep and starting the hot air purge. During the hot air purge a target catalyst bed temperature of 150° F. if preferred. The hot air purge is useful in the laboratory setting as a verification and demonstration of completion of the oxidation reactions. One of skill in the art may appreciate, however, that this step of the laboratory scale procedure may not be reflective of commercial or industrial scale methods. In such commercial applications, the reactor vessel may not be heated during air purging, but rather ventilated in accordance with standard confined space vessel entry procedures at standard ambient temperatures to allow for bodily entry of catalyst handling technicians. During this step, other sub-steps may be performed such as:
a. Monitoring the reactor temperature for run/walk away conditions. As used herein “run/walk away conditions” are defined as an uncontrolled increase in operating temperature above the target operating temperature which will progress to an unsafe operating range without external intervention. Run away conditions refers to rapid increases in temperature while walk away conditions refers to a slower increase in temperature; both are uncontrolled events. Such conditions may occur in various situations such as, for example, when the amount of oxidizing reactant is the limiting reagent for sub-stoichiometric testing;
b. Monitoring the vent gases downstream of the reactor vessel for products of combustion. During this monitoring, the primary focus can be on combustion of metal sulfides, especially when the amount of oxidizing reactant is the limiting reagent for sub-stoichiometric testing; and
c. If, during the hot air purge increased products of combustion are detected and/or reactor temperatures begin to rise undesirably or uncontrollably, switching the gas flow from the hot air purge back to nitrogen and cool the reactor to ambient temperature.

12. Once the hot air purge is complete, cooling the reactor to ambient temperature.

13. Collecting spent catalyst materials from the reactor and the effluent from the separation flask for follow-up testing with respect to, for example, metal sulfides content.

### Example 1—Baseline Evaluation

In this example, 30 ml of spent NiMo catalyst (described above) was treated with 60 ml of H₂O.

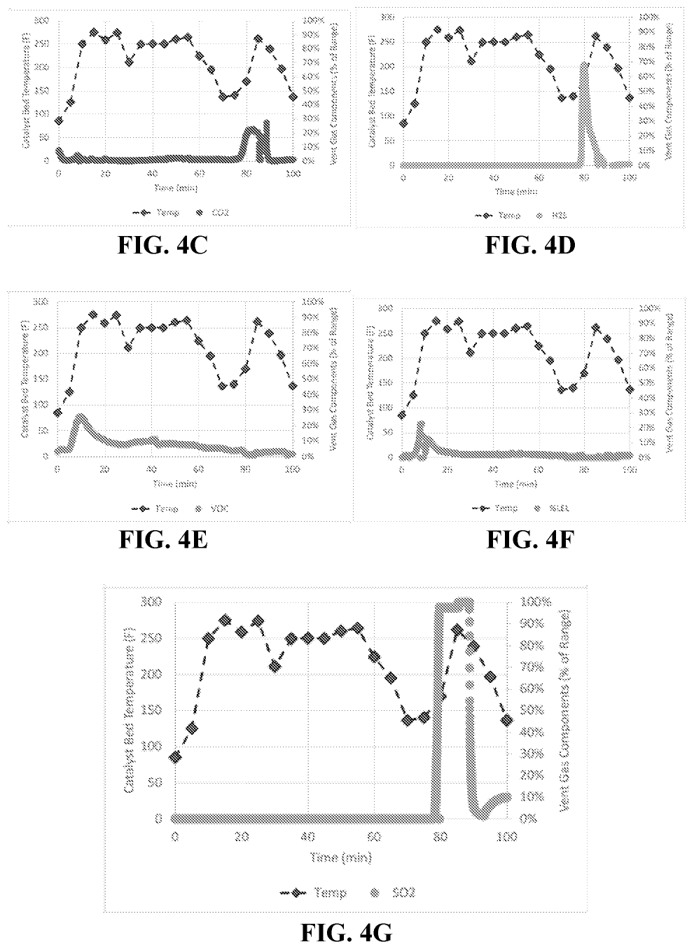

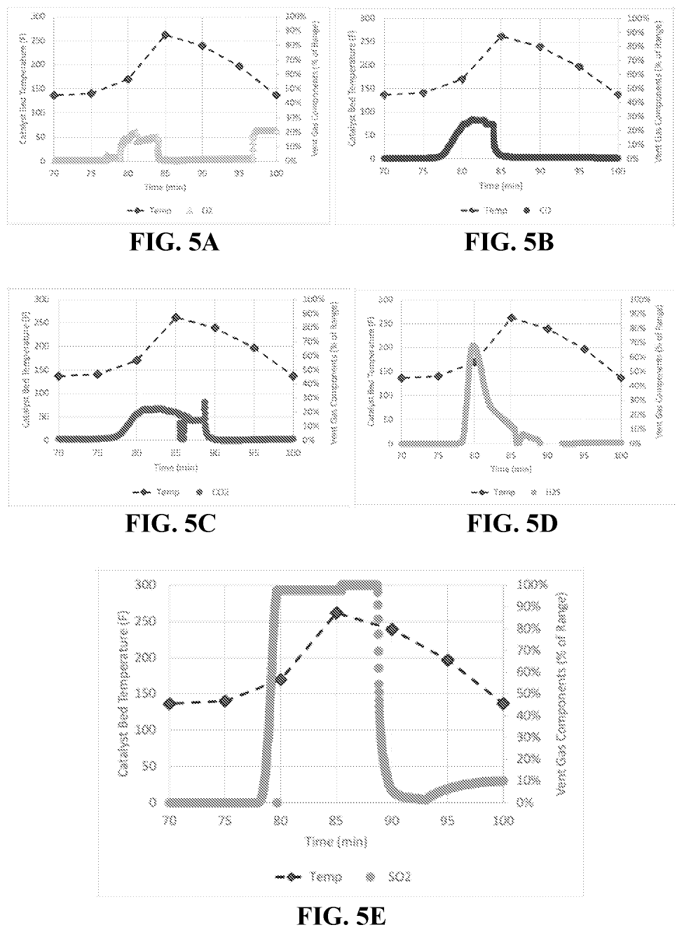

The baseline evaluation was performed to demonstrate the reactivity of spent catalyst in an oxygen rich environment as well as a means to verify the use of SO₂, H₂S and excess heat generation among other combustion products as markers for oxidation reactions. The results of this example highlight that the injection of water into the catalyst bed does not result in the release of oxidation products. However, when exposed to an air purge stream the spent catalyst releases a variety of off-gases including SO₂ and H₂S. In addition to the release of combustion products during the air purge, the reactor vessel temperature increased rapidly as a result of heat release. This necessitated inerting the reaction vessel with a nitrogen purge to stop the self-propagating exothermic reaction. FIGS. 4A-G illustrate the O₂, CO, CO₂, H₂S, VOC, % LEL and SO₂ off-gas readings over the period of the test as well as the logged reactor temperature readings. Water injection into the reactor vessel was initiated at the 10 minute mark and terminated at the 20 minute mark, resulting in an average injection rate of about 6 ml/min. FIGS. 5A-E more specifically illustrate the O₂, CO, CO₂, H₂S and SO₂ off-gas readings during the air purge period.

The data of FIGS. 4A-G indicates an initial small release of volatile organic compounds (“VOCs”) and an increase in the off gas lower explosive limit (the lowest concentration (by percentage) of a gas or vapor in air that is capable of producing a flash of fire in presence of an ignition source; or “% LEL”) readings during the injection of solution. This is consistent with all the testing performed and an indication of trace hydrocarbons still present on the spent catalyst materials released via adsorption of the water and subsequent displacement. However, the injection period did not indicate the release of any off-gases which evidence the oxidation of metal sulfides. Once the catalyst bed was dried and condensation subsided downstream of the reactor vessel, the air purge was initiated at about the 80 minute mark. As can be seen in FIG. 5A, after initiation of the air purge, the oxygen concentration increased to the standard air concentration of oxygen at 20.9%. Correspondingly, several gas concentrations rapidly increased to very high levels as shown in percentage of the testing range. Notably SO₂, H₂S, CO₂, and CO, which are all products of combustion (both combustion of the metal sulfides present on the spent catalyst as well as coke present on the spent catalyst), all increased rapidly. Specifically, the concentration of SO₂ peaked at the maximum value for the measurement range of 24,400 ppm at the 85 minute mark, the concentration of H₂S peaked at 1360 ppm at the 80 minute mark, the concentration of CO₂ peaked at 1.44 vol % at the 88 minute mark, and the concentration of CO peaked at 1800 ppm at the 81 minute mark in the off-gas stream. These combustion gases were present in the purge gas stream from about the 80 minute mark until the 90 minute mark. In addition to the combustion products, the reactor temperature also rapidly increased, highlighting the exothermic nature of combustion reactions upon subjecting to oxygen. The rapid increase in reactor temperature required intervention and the re-introduction of an inert gas purge to prevent further self-propagation of the combustion reactions.

### Example 2—Sub-Stoichiometric Oxidizing Agent Treatment Evaluation

In this example, 30 ml (20 g) of spent NiMo catalyst (described above) was treated with 20 ml of a 5 wt. % NaNO₂, 1 wt % LDAO, and 1 wt % Na₂HPO₄ solution (25% stoichiometric equivalent of NaNO₂).

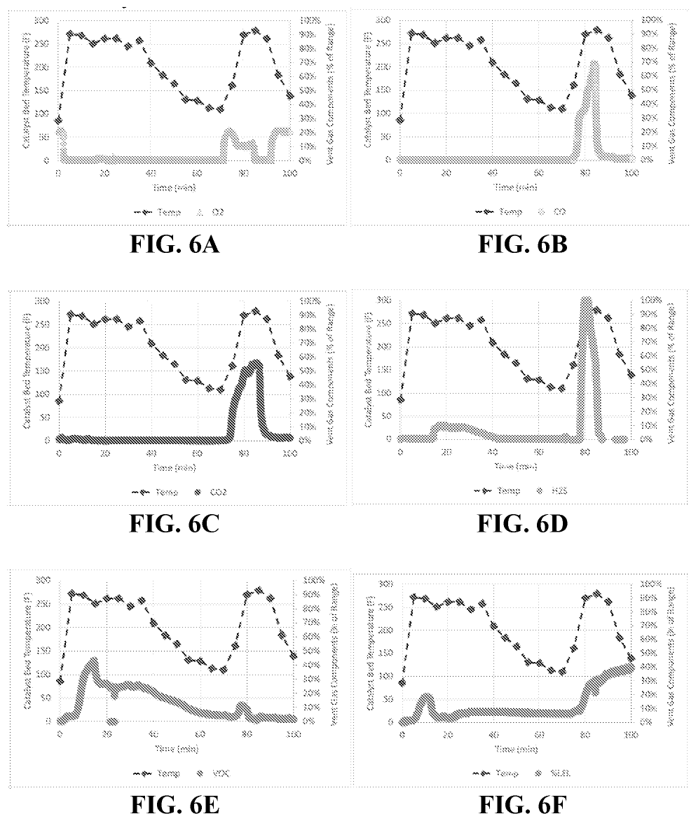

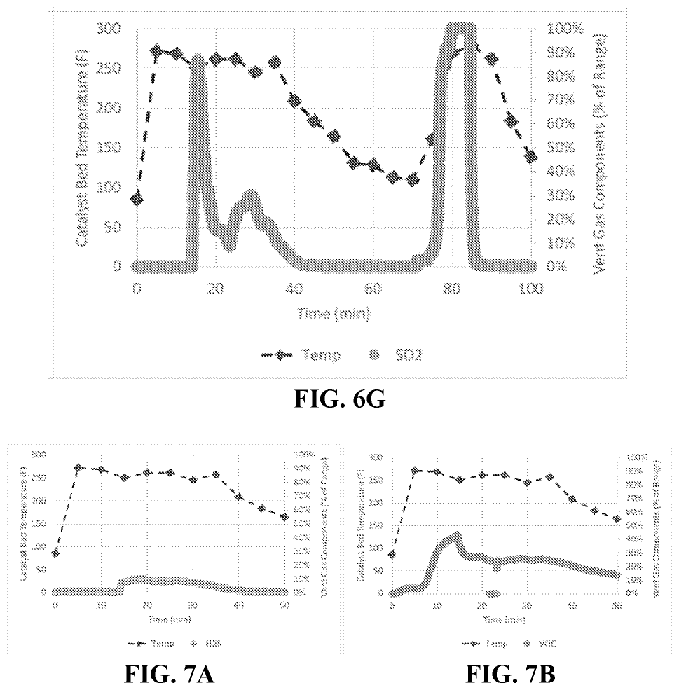

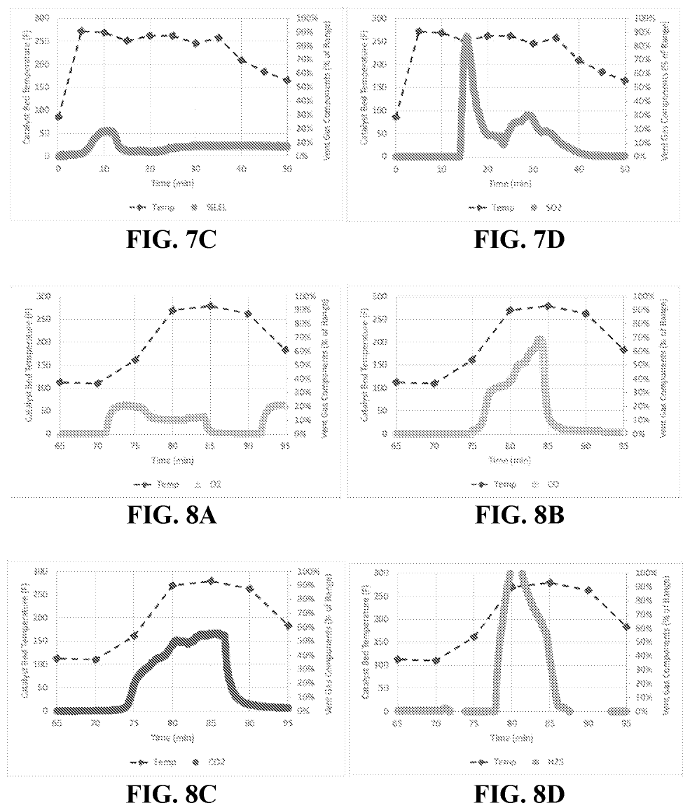

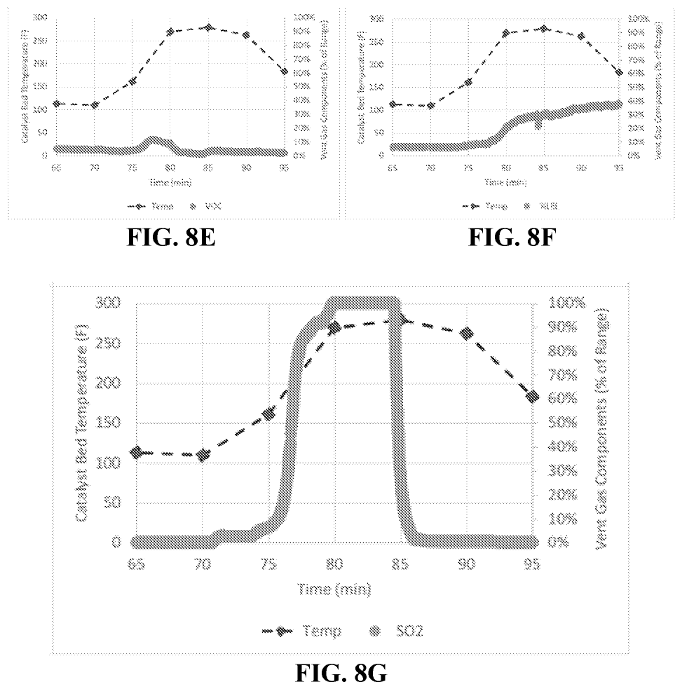

This example highlights that an optimal conversion of metal sulfides is required to prevent the spontaneous reactivity of spent catalyst materials, even after treated with an oxidizing solution. The results of this example illustrate that the injection of even a small amount of low concentration oxidizing solution result in the release of oxidation products. However, when exposed to an air purge stream the spent catalyst material continues to exhibit reactive behavior due to under-treatment resulting in the continued presence of unreacted metal sulfides. In addition to the release of combustion products, the reactor temperature increased rapidly during the air purge as a result of heat release. This required inerting the reaction vessel with a nitrogen purge to stop the self-propagating exothermic reaction. FIGS. 6A-G are graphs illustrating the O₂, CO, CO₂, H₂S, VOC, % LEL and SO₂ off-gas readings over the period of the example as well as the logged reactor temperature readings. FIGS. 7A-D more specifically illustrates the off-gas readings during and immediately subsequent to the oxidizing agent solution injection period. Injection of the 5 wt. % NaNO₂, 1 wt % LDAO, and 1 wt % Na₂HPO₄ solution into the reactor vessel was initiated at the 10 minute mark and terminated at the 25 minute mark, resulting in an average injection rate of about 1.3 ml/min. During the injection the LDAO acted to produce foam in the catalyst bed providing distribution and even coverage to the catalyst bed surfaces. The disodium phosphate also acted as a buffer and the pH of the effluent collected from the reactor measured a value of 7. FIGS. 8A-F more specifically illustrate the O₂, CO, CO₂, H₂S, VOC, % LEL and SO₂ off-gas readings during the air purge period.

The data of FIGS. 6A-8G illustrates a strong correlation between the release of SO₂ and H₂S to the injection of oxidizing solution, confirming the oxidation of metal sulfides on the spent catalyst. An observable amount of VOCs are also released due to injection of the oxidizing solution. The injection also results in a reduction of reactor temperature resulting from the injection of cold reactant as well as supporting endothermic reaction mechanisms discussed above. Both of these effects, cold (ambient, relative to the reactor operating temperature) solution injection and endothermic reaction mechanisms, well offset the exotherm associated with the known phenomenon of heat release due to catalyst bed wetting as well as heat released due to associated the exothermic reaction mechanisms identified. It was noted during the experiment that the reactor vessel heater was on and actively heating the vessel to maintain the target temperature set point. During injection, the concentration of SO₂ peaked at the maximum value of 21,200 ppm at the 15 minute mark and the concentration of H₂S peaked at 200 ppm at the 16 minute mark in the off-gas stream. Following the injection, the reaction off-gases reduce in the vent gas stream, showing a consumption of the reactants present. Once the catalyst bed was dried and condensation subsided downstream of the reactor vessel, the air purge was initiated at 70 minute mark. After initiation of the air purge, the oxygen concentration increased to the standard air concentration of oxygen at 20.9%. Correspondingly, several gas concentrations rapidly increase to very high levels as shown in percentage of the testing range. Notably SO₂, H₂S, CO₂, and CO, which are all products of combustion (both combustion of the metal sulfides present on the catalyst as well as coke present on the spent catalyst), all increase rapidly. Specifically, the concentration of SO₂ peaked at the maximum value for the measurement range of 24,400 ppm at the 79 minute mark, the concentration of H₂S peaked at 2220 ppm at the 80 minute mark, the concentration of CO₂ peaked at 2.95 vol % at the 84 minute mark, and the concentration of CO peaked at 4480 ppm at the 83 minute mark in the off-gas stream. In addition, to the combustion products the reactor temperature also rapidly increases, highlighting the exothermic nature of combustion reactions.

### Example 3—Stoichiometric Oxidizing Agent Treatment Evaluation

In this example, 30 ml of spent NiMo catalyst (described above) was treated with 40 ml of a 10 wt % NaNO₂ solution (95% stoichiometric equivalent of NaNO₂).

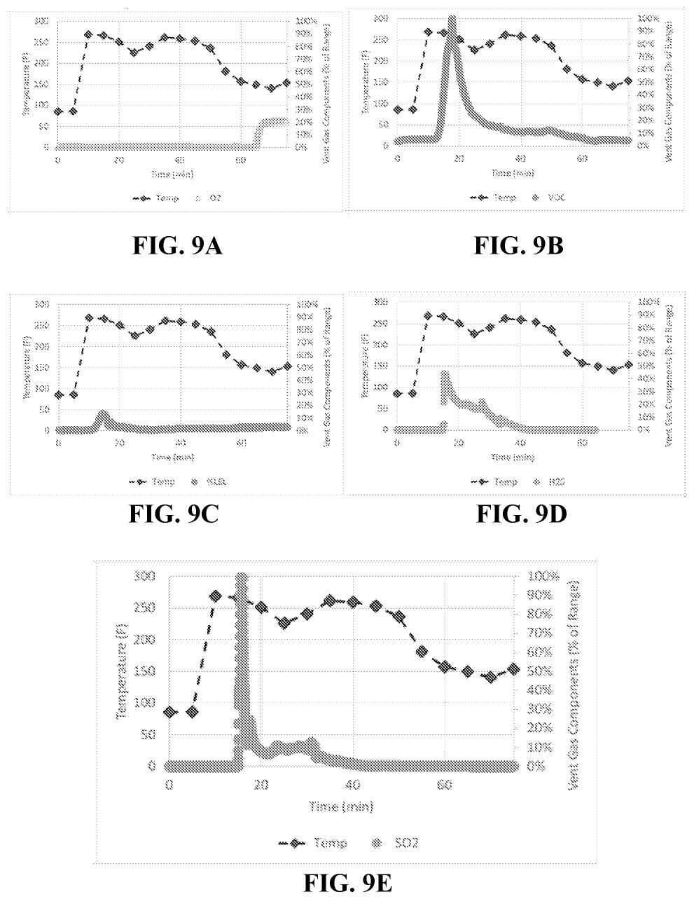

In this example, approximately 95% of the theoretically required oxidizing agent is used to perform a complete conversion of the metal sulfides. In addition, this example includes the application of a more concentrated solution to evaluate its impact on reactor temperature during injection and concomitant formation of reaction products. The results of the example illustrate that the injection of higher concentration solutions do not impact the reactor temperature control. In fact, a notable observation from this example is that the reactor vessel cools during injection of the oxidizing agent solution, which is evidence of an endothermic process coupled with the effects of the injection of a cold oxidizing agent solution. To counteract the endothermic nature of the reaction and the cooling effects of the oxidizing agent solution, the reaction vessel was heated to maintain temperature during the injection phase. FIGS. 9A-E are graphs illustrating the O₂, VOC, % LEL, H₂S and SO₂ off-gas readings over the period of the example as well as the logged reactor temperature readings. FIGS. 10A-D more specifically illustrates the VOC, % LEL, H₂S and SO₂ off-gas readings during and immediately subsequent to the oxidizing agent solution injection period. The relative amounts of CO and CO₂ in vent gas were each about 0% during the course of the experiment. Injection of the 10 wt % NaNO₂ solution into the reactor vessel was initiated at the 15 minute mark and terminated at the 28 minute mark, resulting in an average injection rate of about 3.1 ml/min. The oxidizing agent solution injected during this example did not contain LDAO and as such the foaming effects were not observed which given a larger vessel diameter could have potential impacts on distribution when applied in commercial scale vessels. The oxidizing agent solution injected during this example also did not contain a pH buffer and, as such, the pH of the effluent collected from the reactor measured a value of 5.

The data of FIGS. 9 and 10 illustrates a strong correlation between the release of SO₂ and H₂S to the injection of oxidizing solution confirming the oxidation of metal sulfides on the spent catalyst. During injection, the concentration of SO₂ peaked at the maximum value of 33,200 ppm at the 16 minute mark and the concentration of H₂S peaked at 800 ppm at the 16 minute mark in the off-gas stream. The gas concentrations peaked rapidly following the initial injection at the 15 minute mark and higher concentrations of off-gases continued to be generated until the 25 minute mark when most of the apparent conversion had been completed. Following the injection, the off gases reduce in the vent gas stream showing a consumption of the reactants present. Once the catalyst bed was dried and condensation subsided downstream of the reactor vessel the air purge was initiated at the 65 minute mark. The oxygen concentration increased to the standard air concentration of oxygen at 20.9%. When exposed to an air purge stream, the spent catalyst material did not exhibit a self-propagating exothermic reactive nature and did not exhibit additional SO₂ or H₂S release, indicating that use of a stoichiometric amount of oxidizing agent resulted in substantially complete conversion of metal sulfides.

### Example 4—Excess Oxidizing Agent Treatment Evaluation

In this example, 30 ml of spent NiMo catalyst (described above) was treated with 60 ml of a 10 wt % NaNO₂, 0.8 wt % LDAO and 0.8 wt % Na₂HPO₄ solution (140% stoichiometric equivalent of NaNO₂).

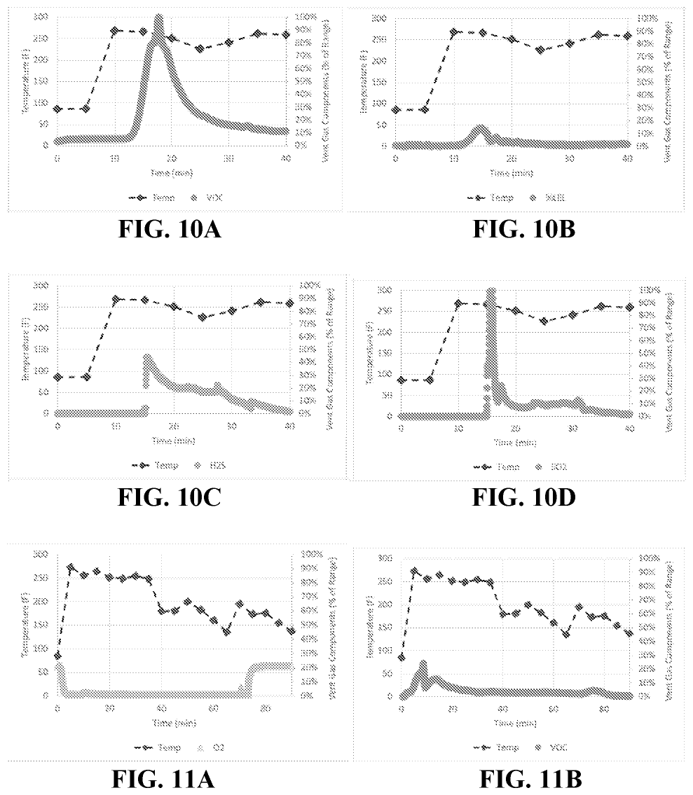

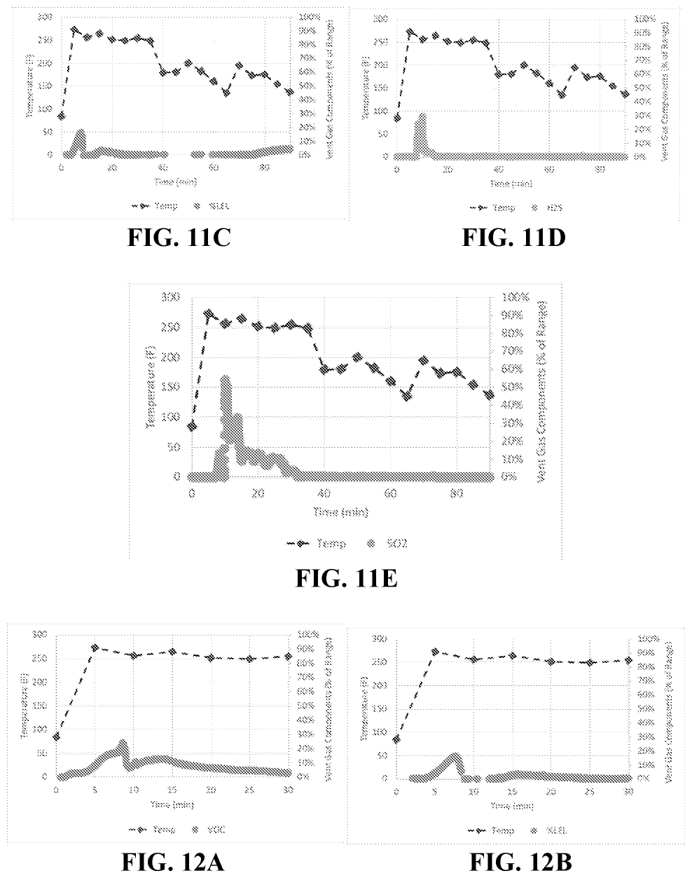

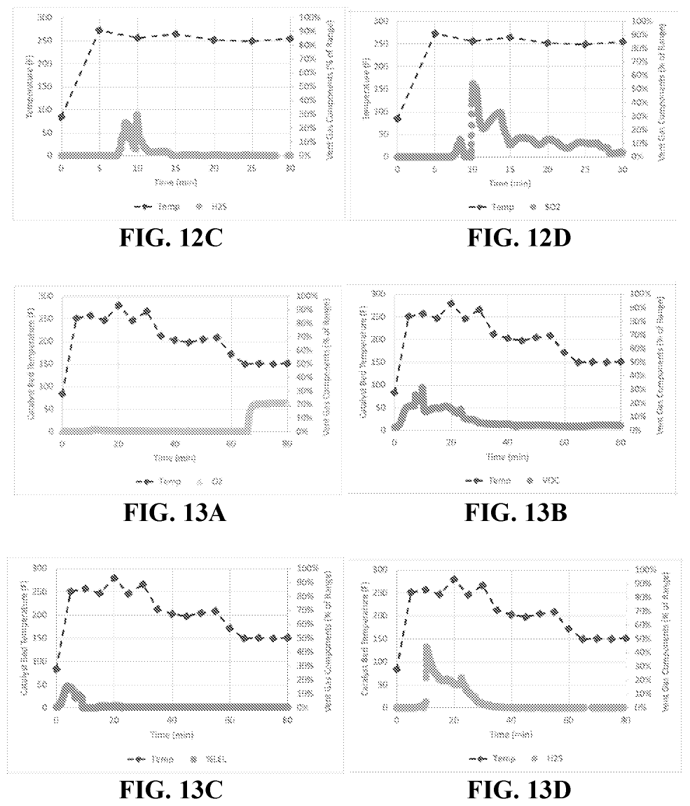

In this example, 140% of the theoretically required oxidizing agent to perform a complete conversion of the metal sulfides was injected. In addition, this test includes the application of a 10% concentrated solution. The results of this example illustrate that the injection of higher concentration solutions and excess reactants do not impact the reactor temperature control or result in the release of additional off-gases. FIGS. 11A-E are graphs illustrating the O₂, VOC, % LEL, H₂S and SO₂ off-gas readings over the period of the example as well as the logged reactor temperature readings. FIGS. 12A-D more specifically illustrates the VOC, % LEL, H₂S and SO₂ off-gas readings during and immediately subsequent to the oxidizing agent solution injection period. The relative amounts of CO and CO₂ in vent gas were each about 0% during the course of the experiment. Injection of the 10 wt % NaNO₂, 0.8 wt % LDAO and 0.8 wt % Na₂HPO₄ solution into the reactor vessel was initiated at the 7 minute mark and terminated at the 28 minute mark. The injection consisted of three separate injections of 20 ml of the aforementioned solution. The first injection of 20 ml was performed rapidly from minute mark 7 to minute mark 10, resulting in an average injection rate of 6.7 ml/min. The second injection of 20 ml was also performed more slowly from minute mark 12 to minute mark 20, resulting in an average injection rate of 2.5 ml/min. The third injection of 20 ml was also performed more slowly from minute mark 21 to minute mark 28, resulting in an average injection rate of 2.9 ml/min. It is important to note that the foaming action was observed throughout the example in the catalyst bed but not always present at the reactor outlet. LDAO when consumed in oxidation reactions does not result in foaming, but when available in excess will result in the formation of foam. Thus, the presence of foam and unreacted which can be measured via test strips at the reactor outlet serves as an indicator of completion of oxidation reactions. Further the disodium phosphate also acted as a buffer and the pH of the effluent collected from the reactor measured a value of 8.

The data of FIGS. 11 and 12 illustrates a strong correlation between the release of SO₂ and H₂S to the injection of oxidizing solution, confirming the oxidation of metal sulfides on the spent catalyst. During injection, the concentration of SO₂ peaked at the maximum value of 13,200 ppm at the 10 minute mark and the concentration of H₂S peaked at 800 ppm at the 10 minute mark in the off-gas stream. The gas concentrations peaked rapidly following the initial injection with subsequent smaller peaks in concentration for subsequent injections. However, concentrations of off-gases continued to be generated until the 25 minute mark when most of the apparent conversion had been completed. It is also notable that foam formed at the reactor outlet at the 25 min mark and continued to persist throughout the balance of the example. Following the injection, the off gases reduce in the vent gas stream showing a consumption of the reactants present. The application of excess reactant also does not result in the release of additional components, indicating that the oxidizing solution selectively reacts with the metal sulfides and does not produce adverse byproducts. Once the catalyst bed was dried and condensation subsided downstream of the reactor vessel, the air purge was initiated at the 75 minute mark. The oxygen concentration increased to the standard air concentration of oxygen at 20.9%. When exposed to an air purge stream, the spent catalyst material did not exhibit a self-propagating exothermic reactive nature and did not exhibit additional SO₂ or H₂S release, indicating that use of an excess amount of oxidizing agent resulted in substantially complete conversion of metal sulfides.

### Example 5—Sub-Stoichiometric Oxidizing Agent Treatment Evaluation

In this example, 30 ml of spent NiMo catalyst (described above) was treated with 18 ml of a 20 wt % NaNO₂, 0.5 wt % LDAO and 0.5 wt % Na₂HPO₄ solution (85% stoichiometric equivalent of NaNO₂).

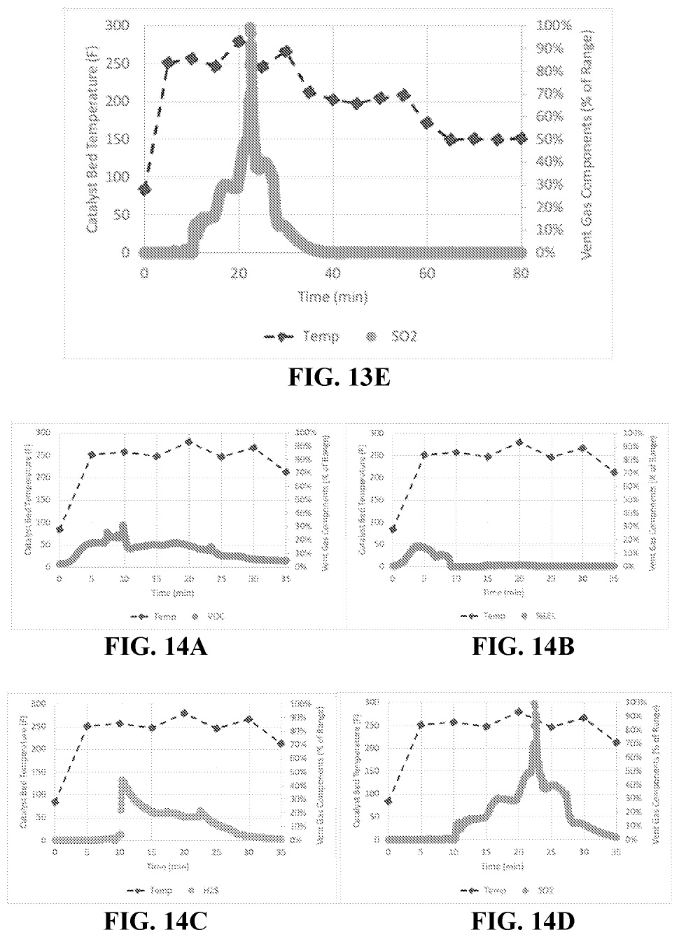

In this example, approximately 85% of the theoretically required oxidizing agent to perform a complete conversion of the metal sulfides was injected. In addition, this example includes the application of a 20 wt % NaNO₂, 0.5 wt % LDAO and 0.5 wt % Na₂HPO₄ concentrated solution. The results of the example illustrate that the injection of even higher concentration solutions do not impact the reactor temperature control or result in the release of additional off gases. FIGS. 13A-E are graph illustrating the O₂, VOC, % LEL, H₂S and SO₂ off-gas readings over the period of the example as well as the logged reactor temperature readings. FIGS. 14A-D more specifically illustrate the VOC, % LEL, H₂S and SO₂ off-gas readings during and immediately subsequent to the oxidizing agent solution injection period. The relative amounts of CO and CO₂ in vent gas were each about 0% during the course of the experiment. Injection of the 20 wt % NaNO₂ and 0.5 wt % LDAO solution into the reactor vessel was initiated at the 10 minute mark and terminated at the 25 minute mark, resulting in an average injection rate of about 1.2 ml/min.

The data of FIGS. 13 and 14 illustrates a strong correlation between the release of SO₂ and H₂S to the injection of oxidizing solution confirming the oxidation of metal sulfides on the spent catalyst. During injection, the concentration of SO₂ peaked at the maximum value of 33,000 ppm at the 22 minute mark and the concentration of H₂S peaked at 880 ppm at the 10 minute mark in the off-gas stream. Following the injection, the off-gases reduce in the vent gas stream showing a consumption of the reactants present. The relative amounts of CO and CO₂ in vent gas were each about 0% during the course of the experiment. Once the catalyst bed was dried and condensation subsided downstream of the reactor vessel, the air purge is initiated at the 75 minute mark. The oxygen concentration increased to the standard air concentration of oxygen at 20.9%. When exposed to an air purge stream, the spent catalyst material did not exhibit a self-propagating exothermic reactive nature and did not exhibit additional SO₂ or H₂S release. While this application applies only 85% of the stoichiometric requirement the results still indicate that the catalyst material is no longer spontaneously, reactive which implies that ideal conversion is not necessarily required to achieve the target results. This result is consistent with the impact of active site degradation and occlusion due to poisoning and coke formation which impacts catalyst system activity, implying that heavily deactivated catalysts will require less oxidizing solution. Further commercial evidence supports that heavily fouled and coked catalysts have less spontaneous reactivity confirming the conclusions of this experimental data.

### Example 6—Low Temperature-Stoichiometric Oxidizing Agent Treatment Evaluation

In this example, 30 ml of spent NiMo catalyst (described above) was treated with 20 ml of a 20 wt % NaNO₂, 0.5 wt % LDAO and 0.5 wt % Na₂HPO₄ solution (95% stoichiometric equivalent of NaNO₂).

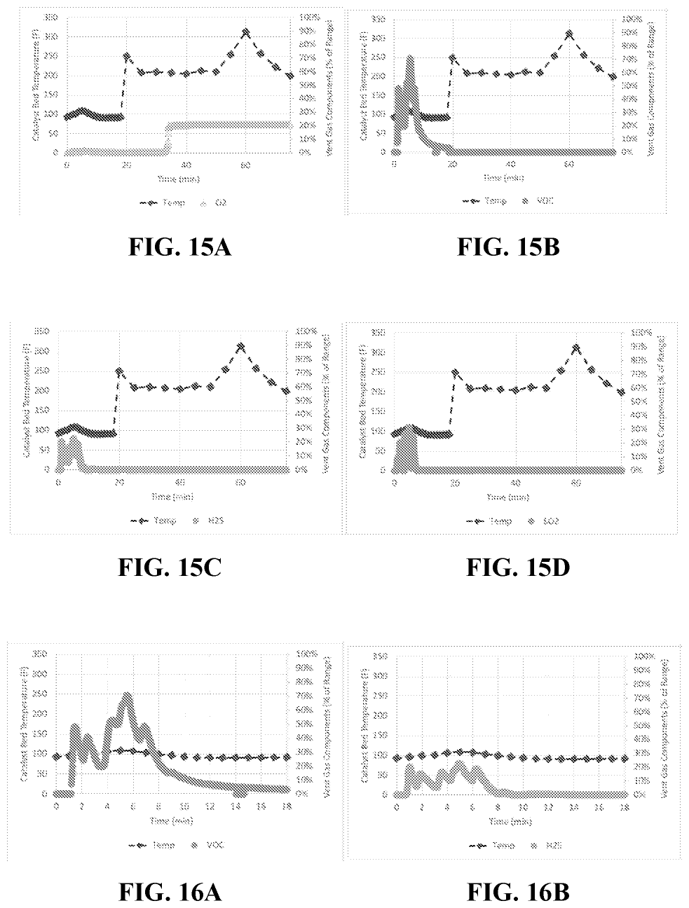

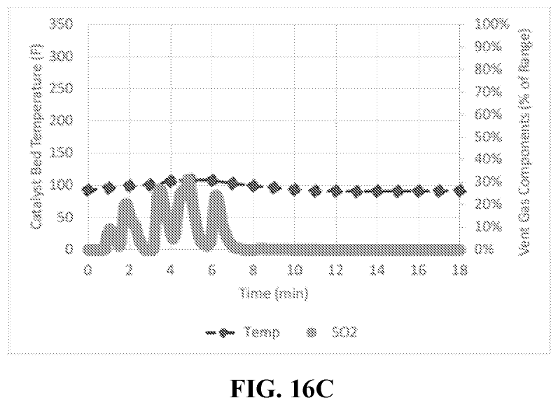

In this example, approximately 95% of the theoretically required oxidizing agent to perform a complete conversion of the metal sulfides was injected. In addition, this example includes the application of the 20 wt % NaNO₂, 0.5 wt % LDAO and 0.5 wt % Na₂HPO₄ concentrated solution starting at ambient temperature conditions. FIGS. 15A-D are graphs illustrating the O₂, VOC, H₂S and SO₂ off-gas readings over the period of the example as well as the logged reactor temperature readings. FIGS. 16A-C more specifically illustrate the VOC, H₂S and SO₂ off-gas readings during and immediately subsequent to the oxidizing agent solution injection period. The relative amounts of CO, CO₂ and % LEL in vent gas were each about 0% during the course of the experiment. The results of the example illustrate the changes in reactor temperature associated with both the initial heat release due to the known heat of absorption phenomenon and the subsequent cooling effects resulting from the oxidation reactions performed.

The data of FIGS. 15 and 16 illustrates a strong correlation between the release of SO₂ and H₂S to the injection of oxidizing solution confirming the oxidation of metal sulfides on the spent catalyst as previously observed. During injection, the concentration of SO₂ peaked at the maximum value of 7650 ppm at the 5 minute mark and the concentration of H₂S peaked at 450 ppm at the 5 minute mark in the off-gas stream. Following the injection, the off-gases reduce in the vent gas stream showing a consumption of the reactants present. Once the catalyst bed was dried and condensation subsided downstream of the reactor vessel, the air purge is initiated at the 35 minute mark. The oxygen concentration increased to the standard air concentration of oxygen at 20.9%. When exposed to an air purge stream, the spent catalyst material did not exhibit a self-propagating exothermic reactive nature and did not exhibit additional SO₂ or H₂S release. While this application was initiated at a lower reactor temperature, it illustrates the metal sulfides will react with the oxidizing agent solution at lower temperatures and the cooling effects of the reaction mechanisms described herein can also be observed subsequent to the effects associated with the heat of absorption.

### Example 7—Commercial Application

In this example, approximately 95% of the theoretically required oxidizing agent to perform a complete conversion of the metal sulfides was injected. In addition, this example includes the application of, as the oxidizing agent formulation, a solution having 20 wt % NaNO₂, 0.5 wt % LDAO and 0.5 wt % Na₂HPO₄ starting at 250° F. The results of the example illustrate the reactor operating conditions throughout the application as well as the subsequent lack of catalyst pyrophoric activity following the application. The commercial application was performed according to various aspects of method 100, whereby the reactor system was treated in its entirety with both the oxidizing agent formulation and phosphate pH buffer solution while purging the reactor system with recycle hydrogen from the process unit's recycle compressor. A representative diagram of the process flow can be seen in FIG. 17.

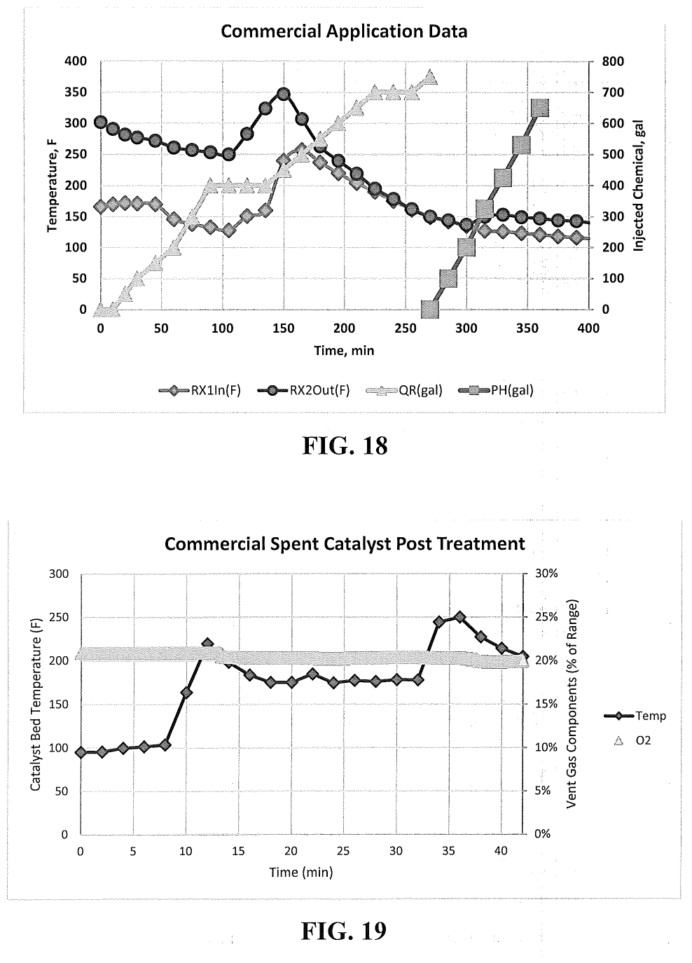

The operating data showing reactor temperatures and chemical injection volumes can be seen in FIG. 18. In FIG. 18, the data line RX1In corresponds to the temperature in ° F. measured at the inlet of the Guard Reactor, the data line RX2Out corresponds to the temperature in ° F. measured at the outlet of the Main Reactor, the data line QR corresponds to the total volume in gallons of oxidizing solution injected, and the data line PH corresponds to the total volume in gallons of pH buffering solution injected.

The data of FIG. 19 illustrates the absence of combustion products from spent catalyst sample material collected during the unloading of the commercial reactor system. The catalyst materials collected were subject to a high temperature purge with air containing 20.9% oxygen in order to demonstrate complete neutralization in the same fashion as the lab samples were subjected to a hot air purge. When exposed to an air purge stream, the spent catalyst material did not exhibit a self-propagating exothermic reactive nature and did not exhibit additional SO₂ or H₂S release. The relative amounts of CO, CO₂, VOCs, H₂S, SO₂ and % LEL in the vent gas were each about 0% during the course of the experiment.

Although the present invention and its objects, features and advantages have been described in detail, other embodiments are encompassed by the invention. All references cited herein are incorporate by reference in their entireties. Finally, those skilled in the art should appreciate that they can readily use the disclosed conception and specific embodiments as a basis for designing or modifying other structures for carrying out the same purposes of the present invention without departing from the scope of the invention as defined by the appended claims.

1. A method of removal metal sulfides from a spent catalyst located within a reactor vessel, the method comprising:
a) purging a reactor vessel containing a spent catalyst;
b) bringing the reactor vessel to a first operating temperature;
c) injecting an oxidizing agent formulation into the reactor vessel;
d) subjecting the reactor vessel to a dry gas purge;
e) bringing the reactor vessel temperature to a second operating temperature; and
f) isolating the reactor vessel from external contaminant sources and introducing air into the reactor vessel.

2. (canceled)

3. The method of claim 1, further comprising monitoring the oxygen content of off-gases expelled from the reactor vessel during the first dry gas purge.

4. The method of claim 1, wherein the oxidizing agent formulation is injected into the reactor vessel continuously, incrementally of variably over a predetermined period of time.

5. The method of claim 1, wherein the oxidizing agent formulation comprises one or more oxidizing agents.

6. The method of claim 1, wherein the oxidizing agent formulation comprises a pH buffer.

7. The method of claim 1, wherein the oxidizing agent formulation comprises one or more water-soluble organic solvents and/or one or more water-soluble surfactants.

8. The method of claim 1, wherein injecting the oxidizing agent formulation into the reactor vessel while maintaining the reactor vessel at the first operating temperature further comprises monitoring off-gases expelled from the reactor vessel H₂S and SO₂.

9. The method of claim 1, wherein subjecting the reactor vessel to the dry gas purge further comprises removing liquid from the reactor vessel and drying the contents of the reactor vessel.

10. The method of claim 1, wherein the metal sulfides comprise one or more of nickel sulfides, molybdenum sulfides, cobalt sulfides, iron sulfides, copper sulfides, tungsten sulfides, titanium sulfides, manganese sulfides, chromium sulfides, noble metal promoted-molybdenum sulfides, non-noble metal promoted-molybdenum sulfides, zinc sulfides, and lead sulfides.

11. The method of claim 1, wherein the oxidizing agent formulation comprises sodium nitrite.

12. The method of claim 11, wherein the oxidizing agent formulation further comprises lauryldimethylamine oxide (LDAO).

13. The method of claim 1, wherein the oxidizing agent formulation comprises lauryldimethylamine oxide (LDAO).

14. The method of claim 1, wherein the oxidizing agent formulation has a pH ranging from about 7 to about 9.5.

15. (canceled)

16. The method of claim 1, wherein c) injecting the oxidizing agent formulation into the reactor vessel is performed while maintaining the reactor vessel at the first operating temperature.

17. The method of claim 1, wherein a) purging the reactor vessel containing the spent catalyst is performed with a dry gas, steam or water.

18. The method of claim 1, further comprising injecting a pH buffering solution into the reaction vessel between steps c) and d).

19. A method of removal metal sulfides from a spent catalyst located within a reactor vessel, the method comprising:
a) purging a reactor vessel containing a spent catalyst;
b) bringing the reactor vessel to a first operating temperature;
c) partially or completely filling the reactor vessel with an oxidizing agent formulation;
d) removing remaining oxidizing agent formulation from the reactor vessel;
e) subjecting the reactor vessel to a first inert gas purge;
f) bringing the reactor vessel to a second operating temperature while subjecting the reactor vessel to a second inert gas purge;
g) bringing the reactor vessel to a third operating temperature; and
h) isolating the reactor vessel from external contaminant sources and introducing air into the reactor vessel.

20. (canceled)

21. The method of claim 19, further comprising monitoring the oxygen content of off-gases expelled from the reactor vessel during the dry gas purge.

22. The method of claim 19, wherein after the reactor vessel has been partially or completely filled with the oxidizing agent formulation, the oxidizing agent formulation is maintained or circulated within the reactor vessel for a period of time.

23-25. (canceled)

26. The method of claim 19, wherein subjecting the reactor vessel to the first inert gas purge further comprises monitoring off-gases expelled from the reactor vessel H₂S and SO₂.

27. The method of claim 19, wherein subjecting the reactor vessel to the second inert gas purge further comprises removing liquid from the reactor vessel and drying the contents of the reactor vessel.

28-33. (canceled)

34. The method of claim 19, wherein c) partially or completely filling the reactor vessel with an oxidizing agent formulation is performed while maintaining the reactor vessel at the first operating temperature.

35. The method of claim 1, wherein a) purging the reactor vessel containing the spent catalyst is performed with a dry gas, steam or water.

36. The method of claim 19, further comprising injecting a pH buffering solution into the reaction vessel between step f) and step g).

37. The method of claim 1, wherein the method further eliminates formation of polythionic and thionic acids, and/or eliminates formation of halide acids in piping and/or components of a reactor system comprising the reactor vessel.

38. The method of claim 19, wherein the method further eliminates formation of polythionic and thionic acids, and/or eliminates formation of halide acids in piping and/or components of a reactor system comprising the reactor vessel.
